(19) United States
(12) Patent Application Publication
(10) Pub. No.: US 2025/0232300 A1
(43) Pub. Date: Jul. 17, 2025

(54) SYSTEMS AND METHODS FOR ENHANCED IDENTIFICATION TO CUSTOMIZE EXPERIENCES

(71) Applicant: Wells Fargo Bank, N.A., San Francisco, CA (US)

(72) Inventors: Darren M. Goetz, Salinas, CA (US); Dennis E. Montenegro, Concord, CA (US)

(73) Assignee: Wells Fargo Bank, N.A., San Francisco, CA (US)

(21) Appl. No.: 17/716,548

(22) Filed: Apr. 8, 2022

(51) Int. Cl. G06Q 20/40; G06Q 20/32

(52) U.S. Cl. CPC G06Q 20/4014; G06Q 20/327; G06Q 20/4015

(57) ABSTRACT

The present disclosure relates to systems and methods for enhanced identification of recurring customers and their devices at enterprise locations. Aspects of the present disclosure relate to utilizing sensors, cameras, and other computing devices to identify the recurring customers and their devices; validating and verifying the identities of the recurring customers; and, generating messages for the customers to improve their experience at enterprise locations.

### TECHNICAL FIELD

The present disclosure relates to systems and methods for enhanced identification of recurring customers and their devices at enterprise locations.

### BACKGROUND

Many customers routinely interact with a service provider (e.g., a business owner that comes to do the same transaction every week), but service providers are unable to identify that customer as being a repeat customer as they approach the service provider, which prevents the service provider from preparing an optimized experience for the repeat customer. As a result, service times for repeat customers tend to be longer than desired. This may lead to customers bypassing transactions, customer frustrations, and/or other undesired occurrences. Technically, identification and verification of repeat customers is difficult to implement in real-time or near real-time. Thus, while it is desirous to quickly identify repeat customers to improve a customer experience, it is a technical challenge to implement.

### SUMMARY

Aspects of the present disclosure relate to utilizing sensors, cameras, and other computing devices to identify recurring customers and their devices, validating and verifying the identities of the recurring customers, and generating messages for the customers to provide various experiences for the customers at enterprise locations and enable the various experiences (e.g., transactions, conversations, etc.).

One embodiment relates to a system. The system includes at least one processing circuit including at least one processor coupled to at least one memory device. The at least one processing circuit is configured to: detect a vehicle associated with a user; detect, from one or more wireless beacons, a user device associated with the user; cause the one or more wireless beacons to establish a communication session with the user device; receive, from the user device via the communication session, a user identifier corresponding to the user; identify, based on the user identifier, a user account of a recurring customer; generate a verification request corresponding to the user account of the recurring customer; receive a user confirmation responsive to the verification request; and generate, responsive to validating the user confirmation, a message based on the user account for presentation to the user.

Another embodiment relates to a method. The method includes detecting, by a processing circuit, a vehicle associated with a user; in response to detecting the vehicle, detecting, by the processing circuit, from one or more wireless beacons, a user device of the user while the user device is within a predefined area; causing, by the processing circuit, the one or more wireless beacons to establish a communication session with the user device; receiving, by the processing circuit, from the user device via the communication session, a user identifier corresponding to the user; identifying, by the processing circuit, based on the user identifier, a user account of a recurring customer; generating, by the processing circuit, a verification request corresponding to the user account of the recurring customer; receiving, by the processing circuit, a user confirmation responsive to the verification request; and generating, by the processing circuit, responsive to validating the user confirmation, a message based on the user account for presentation to the user.

Still another embodiment relates to a non-transitory computer-readable medium storing instructions thereon that, when executed by a processor, causes operations. The operations include: receiving an identifier associated with a vehicle; determining that the identifier corresponds with an account of a customer; retrieving user device information associated with the customer stored in the account; detecting, via one or more wireless beacons, a user device; receiving an identifier associated with the user device; matching the identifier associated with the user device to the user device information associated with the customer stored in the account; identifying the user based on matching the identifier associated with the user device to the user device information and the identifier associated with the vehicle with customer information stored in the account; retrieving and queuing up an experience for the user based on identifying the user and determining that the user device is within a predefined area; and prompting at least one of the user device or the vehicle regarding the experience.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1A is a block diagram of a computing system for identifying and validating recurring customers at enterprise or provider locations, according to an example embodiment;

FIG. 1B is a computing system diagram of the system of FIG. 1A, according to an example embodiment;

FIGS. 2A-2B depict a flow diagram of a method of enhanced identification of repeat customers to customize experiences via the system of FIGS. 1A-1B, according to an example embodiment;

FIGS. 3A-3B depict a flow diagram of a method of identifying a recurring customer to relatively quickly queue up a transaction, according to an example embodiment;

FIGS. 4A and 4B are illustrations of some aspects of a user device user interface, according to example embodiments;

FIGS. 5A and 5B are illustrations of some aspects of a provider device user interface, according to example embodiments;

FIGS. 6A and 6B are illustrations of some aspects of an I/O device user interface, according to example embodiments; and

FIG. 7 is a component diagram of an example computing system suitable for use in at least certain of the various implementations described herein, according to an example embodiment.

### DETAILED DESCRIPTION

This present disclosure addresses the problem of quickly and accurately identifying repeat customers to offer and provide expedited transactions and, more generally, to provide custom experiences for the identified repeat customers. For example, many drive-up banking customers are repeat customers (e.g., a business owner that comes to do the same transaction every week). The present disclosure describes systems, methods, and apparatuses configured to identify the customer before the customer presses the button (or otherwise engages with a banker via their vehicle) to queue up a regular transaction of the customer. The present disclosure addresses logistical issues such as accurately identifying the customer as the customer approaches a branch or other resource (e.g., ATM). As described herein, the present disclosure can reduce customer transaction times and improve overall customer experiences.

The provider computing system can identify the customer in various ways. The provider computing system can identify the customer based on a Bluetooth® transponder provided to the customer. The provider computing system can identify the customer by requesting the customer to check in on their user device. The provider computing system can identify the customer by communicating with a beacon (e.g., garage door clicker) actuated by the customer when they approach the provider location. The beacon can be a multi-button clicker. For example, each button can relate to a different transaction (e.g., a first button indicates a withdrawal of a first predefined amount of money from a first account, a second button indicates a withdrawal of a second predefined amount of money from a second account, and third button indicates that customer assistance is needed). The beacon can be associated with the customer, such as associated with their vehicle. The provider computing system can pair with the beacon (e.g., via a Bluetooth pairing process). The provider computing system can scan a license plate of the customer's vehicle as they drive up to the provider location. The provider computing system can identify the customer by performing a retina scan of the customer (e.g., through a windshield of their vehicle). The provider computing system can identify the customer by receiving a vehicle identifier by pinging the electronic control unit (ECU) of the vehicle to identify the vehicle to cross-reference the vehicle to a known customer. The customer can select a pop-up or other notification on their vehicle (e.g., a graphical user interface provided on a display device of the vehicle) as they enter a geo-fenced area associated with the branch (provider location) to confirm themselves and that they are approaching the provider.

The provider computing system can confirm or verify the determined identity of the customer subsequent to identifying the customer (e.g., their device and/or vehicle). The provider computing system can provide or push a one-time passcode (OTP) automatically upon detection of the customer's registered device. For example, if the vehicle is not being driven by the customer, the person in the car may not be able to complete the at least two-factor authentication. The push or SMS message can be a multi-digit (e.g., six, four, eight, etc.) code that the customer reads to the agent when they reach the teller intercom.

The provider computing system can execute post-confirmation identification activities. For example, the provider computing system can determine that a known customer is arriving and provide a notification to an agent of the provider institution indicating that the known customer is arriving. The provider computing system can generate, display, and/or predictively queue up determined transactions to provide an enhanced greeting/experience to the customer. By determining that the customer is approaching the provider location, the provider computing system can generate an alert for the customer that identifies the fastest lane for the customer to enter (when approaching a drive-up banking lane), instruct the user to use the drive-up ATM instead of the teller and provide an incentive for doing so (e.g., a $1 statement credit), and/or alert the customer that the wait will be long and provide directions to the next nearest provider location. The provider computing system can provide such messages via SMS/Push, through a connected mobile application, via the vehicle dashboard, audio/visual signage at the service provider (e.g., “Welcome Joe. Aisle 3 is open and your teller will be Mark.”), a combination thereof, etc.

Before turning to the Figures, which illustrate certain example implementations in detail, it should be understood that the present disclosure is not limited to the details or methodology set forth in the description or illustrated in the figures. It should also be understood that the terminology used herein is for the purpose of description only and should not be regarded as limiting.

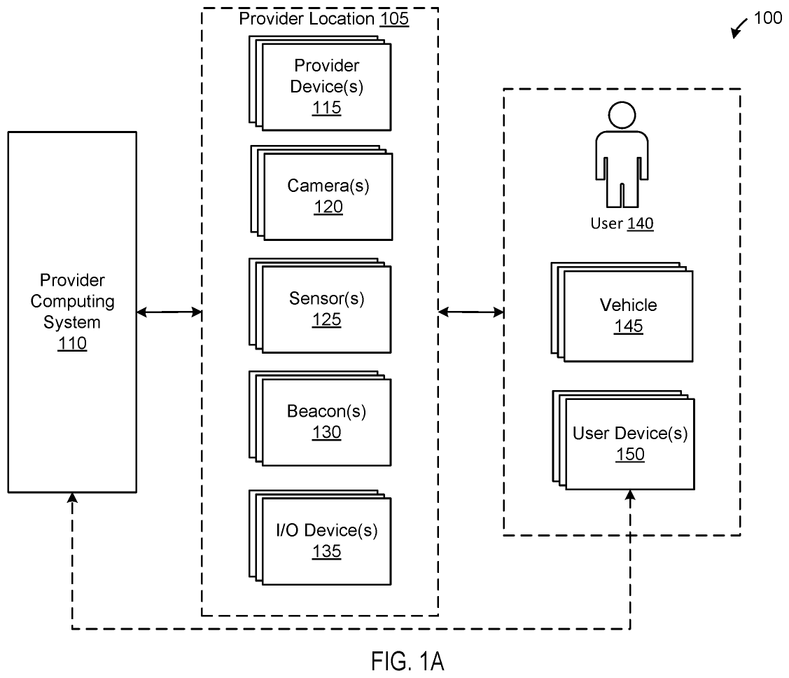

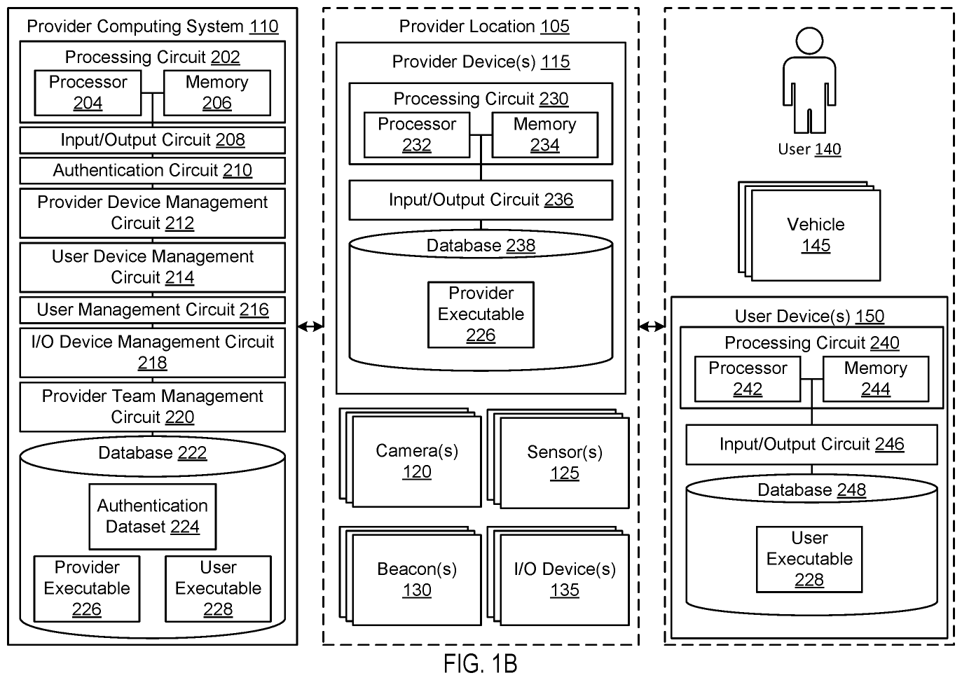

Referring now to FIG. 1A, a block diagram of a system 100 is depicted, according to an example implementation. The system 100 includes a provider location 105. In some implementations, the provider location 105 is associated with a business, store, retail location (e.g., a retail store location), bank, a financial institution (e.g., a branch of a financial institution), and/or the like, which allows customers to perform transactions (e.g., deposits, withdrawals, purchases, or other transactions). The provider location 105 can include provider devices 115, cameras 120, sensor(s) 125, beacon(s) 130, and I/O device(s) 135 communicatively coupled to each other (e.g., via a network). The provider location 105 may include a local computing system that couples to each of these devices. Alternatively, each of these systems/components are directly coupled to a backend, remote provider computing system 110 associated with the provider location 105. The system 100 is further shown to include a user 140, a vehicle 145 associated with the user 140, and user device(s) 150 associated with the user 140. In operation and as described herein, the user 140, the vehicle 145, and/or the user devices 150 physically approach the provider location 105 whereby the provider institution computing system 110 identifies and authenticates the user as a recurring customer and queues up a most likely transaction for execution in order to improve a customer experience and expedite transactions. In some implementations, the system 100 includes more or fewer components than as shown in FIG. 1A. For example, one or more of the provider devices 115, the cameras 120, the sensors 125, the beacons 130, the I/O devices 135, the vehicle 145, or the user devices 150 may be optional components of the system 100.

The provider computing system 110 may be a computing system associated with a provider institution. The provider institution may be a financial institution, such as a credit card issuer, a bank, a payment processing system, etc. The provider computing system 110 may be associated with/coupled to the provider location 105 (e.g., business, store, etc.). In some implementations, the provider computing system 110 is located at the location of the provider location 105. In some implementations and as shown, the provider computing system 110 is a remote computing system such as a remote server, a cloud computing system, and the like. In some implementations, the provider computing system may be part of a larger computing system such as a multi-purpose server or other multi-purpose computing system. In some implementations, the provider computing system 110 may be implemented on a third-party computing device operated by a third-party service provider (e.g., AWS, Azure, GCP, and/or other third party computing services).

The provider device(s) 115 located at the provider location 105 are computing devices configured for use by provider employees or agents (e.g., bank teller). The provider device(s) 115 may include a mobile device (e.g., smartphone, tablet, laptop computer, and so on), a desktop computer, a code scanning tool (e.g., a bar code and/or QR code scanner), a point of sale terminal, etc. In some implementations, the system 100 includes more than one provider device(s) 115.

The cameras 120 located at the provider location 105 are configured as optical instruments and/or video capture devices configured to capture images of the user 140, the vehicle 145, and/or the user devices 150. They may be placed to obtain images of the vehicle, user, and/or user device in drive-up lanes, as the vehicle approaches drive-up lanes, etc. of the provider location. The cameras 120 can include a biometric (e.g., retina, voice, fingerprint, face, etc.) scanner. For example, the cameras 120 can scan the face and/or eyes of the user 140. The provider computing system 110 can cause or request the cameras 120 to capture one or more scans of the user 140, user device 150, and/or vehicle 145. For example, the cameras 120 can be configured to automatically scan the face and/or eyes of the user 140 upon detecting movement or a person (i.e., motion-activated). Based on the scan of the user 140 at the provider location 105, the provider computing system 110 can determine that that the user 140 is at the provider location 105. In another example, the cameras 120 can scan the vehicle 145 of the user 140. The provider computing system 110 can cause or request the cameras 120 to capture one or more scans of the vehicle 145. For example, the cameras 120 can be configured to automatically scan the license plate of the vehicle 145 upon detecting movement of a vehicle. Based on the scan of the vehicle 145 at the provider location 105, the provider computing system 110 can determine that the vehicle 145 and/or user is at the provider location 105. In another example, the cameras 120 can scan (e.g., acquire one or more images regarding) the user devices 150 of the user 140. The provider computing system 110 can cause or request the cameras 120 to capture one or more scans of the user devices 150. For example, the cameras 120 can be configured to scan a code (e.g., QR code, bar code, etc.) from a display of the user device 150. Based on the scan of the user devices 150 at the provider location 105, the provider computing system 110 can determine that that the user 140 is at the provider location 105.

The sensors 125 located at the provider location 105 may facilitate identifying or sensing the user 140 (e.g., customer), the vehicle 145, and/or user devices 150. For example, the sensor 125 may include a motion detector, a near field communication (NFC) transceiver, and/or other suitable sensing device. The sensors 125 may include any physical sensor structured to detect one or more parameters of the user 140 and/or user device 150 for predictively queuing up and determining transactions as described herein. For example, the one or more sensors 125 may be structured to detect a biometric input, an audio input, and so on. The sensors 125 may be various sensors, such as infrared sensors, LIDAR sensors, motion-sensors, etc.

The beacons 130 located at the provider location 105 may facilitate establishing communications with the vehicle 145 and/or the user devices 150. For example, the beacons 130 may be transponders, access points, transceivers, or any other communication device. For example, the beacons 130 may be structured to establish Wi-Fi, Bluetooth, or another wireless communication protocol communication session with the vehicle 145 or the user devices 150. For example the beacons 130 may include a wireless or wired transceiver capable of establishing communication between the provider device 115 and the user device 150 using a wired or wireless connection, such as Ethernet, Wi-Fi, Bluetooth, NFC, etc.

In an example implementation, the beacons 130 may include a positioning sensor, such as a GPS, that is structured to determine a location of the vehicle 145 and/or the user device 150. The beacons 130 may provide the location information to the provider computing system 110. In some implementations, the beacons 130 may have on-board computing systems for controlling the operation of the beacons 130. In some implementations, the beacons 130 may have control circuitry and a communication interface such that the operations of the beacons 130 are controlled by the provider computing system 110.

The one or more I/O devices 135 located at the provider location 105 may include any input, output, and/or input/output device. For example, the one or more I/O devices 135 may include digital signage that is used to convey messages to customers (e.g., indicate which lanes are open, direct traffic, etc.). The one or more I/O devices 135 may include display devices, speakers, and the like.

In some implementations, the I/O device 135 may include an ATM. The ATM may include a communications interface that couples the ATM over a network to the provider computing system 110 such that information may be exchanged. The ATM may include one or more sensing devices (e.g., cameras, etc.) that may relay detected information to the provider computing system 110. The provider institution computing system 110 may further provide one or more instructions to the ATM to cause the ATM to perform various actions, such as queuing up a transaction, unlocking to show particular account information, activating of the sensing device(s) to acquire certain information, etc. in response to identifying and verifying the identity of the recurring customer.

The vehicle 145 can be an off-road and/or on-road vehicle including, but not limited to, cars, vans, motorcycles, mopeds, trucks, semi-trucks (e.g., line-haul trucks, etc.), and/or any other vehicle. The vehicle 145 can include communication interfaces such as Bluetooth transponders, Wi-Fi adapters, NFC pucks, garage clickers, and/or other mechanisms for communicating with the components located at the provider location 105 and/or the provider computing system 110. For example, the vehicle 145 can communicate with the beacons 130 via a wireless transceiver (e.g., Bluetooth transponder) included with the vehicle 145. As another example, the vehicle 145 may include a network interface that facilitates coupling of the vehicle 145 to a network to communicate with the provider computing system 110. The vehicle 145 can include display devices (e.g., an infotainment center) to provide various information to a user, such as display transactions and information regarding the vehicle 145 (e.g., mileage, current speed, maintenance information, etc.). The vehicle 145 can include input interfaces such as a touch screen to receive inputs from the user 140 for interacting with the services provided at the provider location 105 and/or the provider computing system 110 more generally.

The user device(s) 150 can be a computing system for use by the user 140. In the example shown, the user 140 is a repeat customer of the provider institution associated with the provider location 105 and provider computing system 110. Thus, the user 140 may have one or more accounts maintained by the provider computing system 110 (e.g., a demand deposit account, a mortgage account, etc.). In some implementations, the user device(s) 150 may include a mobile device (e.g., smartphone, tablet, a laptop computer, etc.), a desktop computer, wearable devices (e.g., smart watch, smart glasses, etc.), and/or the like. In some implementations, the system 100 includes more than one user device 150 of the user 140. For example, the user 140 can be associated with a first user device 150, which is a smartphone, and a second user device 150, which is a garage clicker disposed in the vehicle 145 of the user 140. The provider computing system 110 can pair or establish communications between the garage clicker and the beacons 130. For example, the garage clicker can transmit tokens (further described below) to the beacons 130 for identifying the user 140 and/or vehicle.

With the above in mind, referring now to FIG. 1B, a detailed computing system diagram of the system 100 is shown, according to an example implementation. Each of the components of the system 100 is in communication with each other via a network. In other embodiments, some of the components may be coupled via a wireless and/or wired connection (e.g., hard-wired together). Specifically, the provider computing system 110, the components of the provider location 105 (e.g., provider devices 115, the cameras 120, the sensors 125, the beacons 130, and the I/O devices 1135), the vehicle 145, and the user devices 150 are communicatively coupled to the network such that the network permits the direct or indirect exchange of data, values, instructions, messages, and the like (represented by the double-headed arrows in FIG. 1A). In some implementations, the network is configured to communicatively couple to additional computing system(s). For example, the network may facilitate communication of data between the provider computing system 110 and other computing systems associated with the service provider or with a customer of the service provider such as the user device (e.g., a mobile device, smartphone, desktop computer, laptop computer, tablet, or any other computing system). The network may include one or more of a cellular network, the Internet, Wi-Fi, Wi-Max, a proprietary provider network, a proprietary retail or service provider network, and/or any other kind of wireless and/or wired network.

As shown in FIG. 1B, the provider computing system 110 includes a processing circuit 202 having a processor 204 coupled to a memory 206, an input/output (I/O) circuit 208, an authentication circuit 210, a provider device management circuit 212, a user device management circuit 214, a user management circuit 216, an I/O device management circuit 218, a provider team management circuit 220, and a database 222. The provider computing system 110 includes hardware, software, or any combination of hardware and software structured to facilitate operations of the components of the system 100. The specialized circuits include any combination of hardware and software to identify recurring customers and predictively queue up and determine transactions for the identified recurring customers. In some implementations, the provider computing system 110 may include any combination of hardware and software including specialized processing circuits, applications, executables, and the like for controlling, managing, or facilitating the operation of the other computing systems of the system 100 including the provider device(s) 115, the cameras 120, the sensors 125, the beacons 130, the I/O devices 135, the vehicle 145, and/or the user devices 150. For example, the provider computing system 110 may include additional processing circuits and associated software for controlling the operation of various components, devices, and/or systems of the system 100. The additional specialized circuits may be substantially similar to the specialized processing circuits described herein below.

The processing circuit 202 may be coupled to the input/output circuit 208, the authentication circuit 210, the provider device management circuit 212, the user device management circuit 214, the user management circuit 216, the I/O device management circuit 218, the provider team management circuit 220, and/or the database 222. The processing circuit 202 may include a processor 204 and a memory 206. The memory 206 may be one or more devices (e.g., RAM, ROM, Flash memory, hard disk storage) for storing data and/or computer code (e.g., instructions). The memory 206 may be or include non-transient volatile memory, non-volatile memory, and non-transitory computer storage media. The memory 206 may include database components, object code components, script components, or any other type of information structure for supporting the various activities and information structures described herein. The memory 206 may be communicatively coupled to the processor 204 and include computer code or instructions for executing one or more processes described herein. The processor 204 may be implemented as one or more application specific integrated circuits (ASICs), field programmable gate arrays (FPGAs), a group of processing components, or other suitable electronic processing components. As such, the provider computing system 110 is configured to run a variety of application programs and store associated data in a database of the memory 206 (e.g., database 222).

The input/output circuit 208 is structured to receive communications from and provide communications to other computing devices coupled to the provider computing system 110. The input/output circuit 208 is structured to exchange data, communications, instructions, and the like with input/output devices of the components of the system 100. In some implementations, the input/output circuit 208 includes communication circuitry for facilitating the exchange of data, values, messages, and the like between the input/output circuit 208 and the components of the provider computing system 110. In some implementations, the input/output circuit 208 includes machine-readable media for facilitating the exchange of information between the input/output circuit 208 and the components of the provider computing system 110. In some implementations, the input/output circuit 208 includes any combination of hardware components, communication circuitry, and machine-readable media.

In some implementations, the I/O circuit 208 may include a network interface. The network interface may be used to establish connections with other computing devices by way of the network. The network interface may include program logic that facilitates connection of the provider computing system 110 to the network. In some implementations, the network interface may include any combination of a wireless network transceiver (e.g., a cellular modem, a Bluetooth transceiver, a Wi-Fi transceiver) and/or a wired network transceiver (e.g., an Ethernet transceiver). For example, the I/O circuit 208 may include an Ethernet device such as an Ethernet card and machine-readable media such as an Ethernet driver configured to facilitate connections with the network. In some implementations, the network interface includes the hardware and machine-readable media sufficient to support communication over multiple channels of data communication. Further, in some implementations, the network interface includes cryptography capabilities to establish a secure or relatively secure communication session in which data communicated over the session is encrypted.

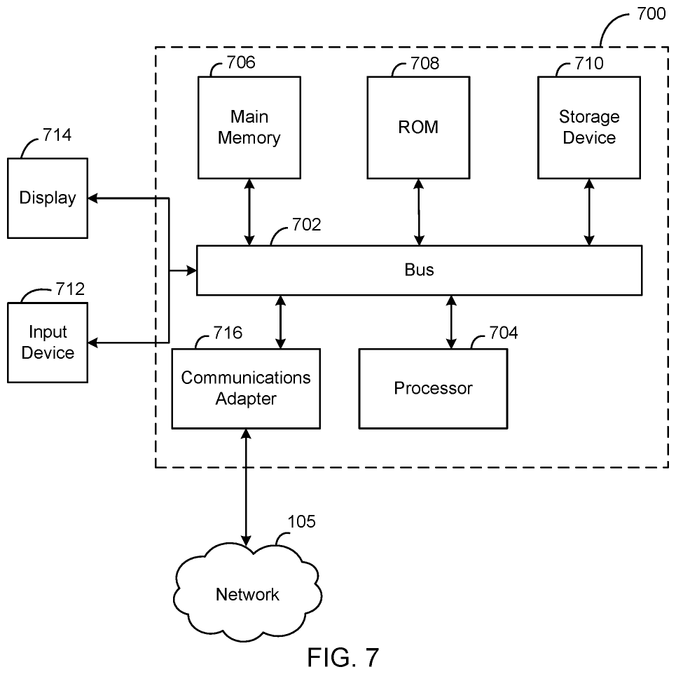

In some implementations, the I/O circuit 208 includes suitable input/output ports and/or uses an interconnect bus (e.g., bus 702 in FIG. 7) for interconnection with a local display (e.g., a liquid crystal display, a touchscreen display) and/or keyboard/mouse devices (when applicable), or the like, serving as a local user interface for programming and/or data entry, retrieval, or other user interaction purposes. As such, the input/output circuit 208 may provide an interface for the user to interact with various applications and/or executables stored on the provider computing system 110. For example, the input/output circuit 208 may include a keyboard, a keypad, a mouse, joystick, a touch screen, a microphone, a biometric device, a virtual reality headset, smart glasses, and the like. As another example, input/output circuit 208, may include, but is not limited to, a television monitor, a computer monitor, a printer, a facsimile, a speaker, and so on.

In some implementations, the I/O circuit 208 may communicably couple to the cameras 120, the sensors 125, and/or the beacons 130 (e.g., via the network). Accordingly, the I/O circuit 208 may be structured to receive image data from the cameras 120. The I/O circuit 208 may be structured to receive sensor data from the sensors 125. The I/O circuit 208 may be structured to receive communication or location data from the beacons 130.

The authentication circuit 210 is structured to authenticate the user 140 for predictively queuing up and determining transactions for the user 140. In some implementations, the authentication circuit 210 is structured to receive (e.g., via the I/O circuit 208) a token or other identifying information regarding the user from one or more components of the system 100. The authentication circuit 210 can use the token or other identifying information to determine whether to grant the user 140 access to the services provided at the provider location 105 (e.g., at the ATM, at a drive-up teller window, etc.). The authentication circuit 210 can parse the token or other identifying information to identify credentials that grant the user 140 access to the services provided at the provider location 105. The token can be a data packet or message that includes information about the user 140 (e.g., a numeric, alphanumeric, alpha and/or other data structure that contains identifying information regarding the user, user device, and/or vehicle among potentially other information). The token may include a transaction identifier (ID), a one-time password (OTP), a wireless connection to a pre-authorized mobile device (e.g., near field connection (NFC), Bluetooth, Wi-Fi, and the like), a personal identification number (PIN), an issued account number, a government issued ID, and/or any other identification or security value associated with a user. The token can contain information regarding the user device and/or vehicle 145.

The authentication circuit 210 can compare the token or other identifying information to the authentication dataset 224 for the user 140. The authentication dataset 224 can include a password, hash, or unique key for the user 140, which may be used to detokenize the token. The authentication dataset 224 may also include user account data associated with a user account such as an account number, an account balance, an account type, authentication data, and/or other data associated with a user account at the FI. The authentication data may include one or more of a password, a PIN, a voice ID, a biometric ID, a FI issued account number, a government issued ID, and so on. In some implementations, the authentication dataset 224 may also store instructions for generating a OTP such that the provider computing system 110 and/or components thereof may generate the OTP. At least one of the authentication data and the OTP may be used to authenticate and identify the user 140.

Authenticating, by the authentication circuit 210, the user 140 based on the token includes receiving the token and comparing the token to the authentication dataset 224 and determining whether the token is included in the authentication dataset 224. For example, the authentication circuit 210 may receive a first token having a first identity data. The authentication circuit 210 may compare the first identity data to the authentication dataset 224 stored in the database 222. If the authentication circuit 210 determines a match between the authentication dataset 224 and the token, then the authentication circuit 210 can grant the user 140 access to the services provided at the provider location 105. For example, if the authentication circuit 210 finds a match, the authentication circuit 210 may provide an indication to one or more components of the provider computing system 110 and/or the system 100 that the first token is verified. Thus, the authentication circuit 210 may utilize one or more de-tokenization processes to detokenize the token to identify/extract information contained therein.

The authentication circuit 210 can determine transactions to queue up for the user 140 based on the verified token or other identifying information. The token may include transaction information to predictively queue up and determine transactions, an indication of the user device 150 associated with the user 140, and/or any other parameter associated with the user 140. The authentication circuit 210 can parse the token to identify the transaction information for queuing up and determining transactions for the user 140. For example, the authentication circuit 210 can identify that the token includes a request to make a deposit into an account of the user 140. Based on the request, the provider computing system 110 can queue up the requested transaction for the user 140 approaching the provider location 105. Thus, in some embodiments, the token defines a particular transaction.

The provider device management circuit 212 is structured to facilitate and enable certain operations of the provider device(s) 115. For example, the provider device management circuit 212 may generate a provider interface (described herein, below). The provider device management circuit 212 may receive provider employee data from the provider device(s) 115. The provider employee data may include a real-time (e.g., updated every second, every minute, etc.) status of each or certain provider employees. Each real-time status includes an indication of a present task that a corresponding provider employee is doing and/or is assigned to in real-time. For example, a provider employee may be assisting a customer with a transaction, on break, idle, and so on. The real-time status may further indicate whether the present task is in progress, recently started, nearing completion, and so on. For example, the real-time status may indicate that a provider employee has recently started a break, the provider employee data may also include employee statistics for each provider employee. The statistics for each provider employee may include: years of experience, average mistakes made per transaction, seniority level, employment history, and/or other parameters associated with each provider employee.

The user device management circuit 214 is structured to facilitate sending and receiving data to/from the user device(s) 150. For example, the user device management circuit 214 may generate a user interface (described herein, below). The user device management circuit 214 may also be structured to receive a request from the user device(s) 150 to predictively queue up and determine transactions. The request may include user data, such as account information, transaction amounts, transaction types, and so on. The request may be received by the user device management circuit 214 (e.g., via the I/O circuit 208 and the network).

In some implementations, the user management circuit 216 is structured to manage data of the users 140 to predictively queue up and determine transactions. The user management circuit 216 can manage account information, transaction parameters (e.g., amounts, types, etc.), transaction preferences (e.g., ATM or teller), biometric information, associated vehicles 145 and/or user devices 150 of the user, and/or any other information about the users 140. For example, the user management circuit 216 can manage identifiers of vehicles 145 (e.g., VIN, controller serial number, etc.) and user devices 150 (e.g., phone or smart watch) associated with the user 140 to identify the user 140 responsive to detecting the vehicles 145 or the user devices 150 approaching the provider location 105. In some implementations, the user management circuit 216 can apply clustering or machine learning techniques to identify users 140 that are similar to each other. For example, if a first user 140 prefers to interact with the teller and drives a large vehicle 145, then the user management circuit 216 can predict that a second user 140 that drives a large vehicle 145 will also prefer to interact with the teller. Based on the prediction, the provider computing system 110 can queue up an available teller for the second user 140 when the second user 140 approaches the provider location 105.

The I/O device management circuit 218 may be structured to send and/or receive data to/from the I/O devices 135. For example, the I/O device 135 may include a display, and the I/O device management circuit 218 may provide image data (e.g., a user interface, a scannable code, an operational status, etc.) to the I/O device 135 such that the image data is displayed by the I/O device 135. The I/O device management circuit 218 may be structured to select an I/O device 135 of a plurality of I/O devices 135 for predictively queuing up and determining transactions, responsive to receiving the request to predictively queue up and determine transactions. In these implementations, the I/O device management circuit 218 may receive data from the I/O devices 135. The I/O device management circuit 218 is structured to select a provider employee for predictively queuing up and determining transactions based on the data from the I/O devices 135. For example, the I/O device management circuit 218 may assign one or more thresholds to one or more parameters of a transaction request including a screen size, technical functions, disability support, a maximum wait time, a maximum mistake risk threshold, and/or thresholds for other parameters related to the I/O device 135 and/or the predictively queued up and determined transactions.

The provider team management circuit 220 may be structured to select a provider employee of a plurality of provider employees for enabling a transaction with the user based on provider employee data. For example, the provider team management circuit 220 may assign one or more thresholds to one or more parameters of a transaction request including a minimum experience level provider employee, a minimum wait time, a maximum wait time, a maximum mistake risk threshold, a minimum seniority level, and/or thresholds for other parameters related to the provider employee and/or the predictively queued up and determined transactions.

The database 222 may retrievably store data associated with the provider computing system 110 and/or any other component of the system 100. That is, the data may include information associated with each of the components of the system 100. For example, the data may include information about the provider device(s) 110, the cameras 120, the sensors 125, the beacons 130, the I/O devices 135, the user 140, the vehicle 145, and/or the user device(s) 150. For example, the information can be a retina scan of the user 140, a license plate/make/model of a vehicle 145 of the user 140, other information regarding the vehicle 145 and other vehicles (e.g., software identification values, etc.), or a usage history of the user 140. The data may be retrievable, viewable, and/or editable by the provider computing system 110 (e.g., by user input via the I/O circuit 208).

In the implementation shown in FIG. 1B, the database 222 stores the authentication dataset 224, a provider executable 226, and a user executable 228. The database 222 may be configured to store one or more applications and/or executables to facilitate operations such as transactions and/or various other operations described herein. In some implementations, the applications and/or executables may be incorporated with an existing application in use by the provider computing system 110. In some implementations, the applications and/or executables are separate software applications implemented on the provider computing system 110. The applications and/or executables may be downloaded by the provider computing system 110 prior to its usage, hard coded into the memory 206 of the processing circuit 202, or be a network-based or web-based interface application such that the provider computing system 110 may provide a web browser to access the application, which may be executed remotely from the provider computing system 110 (e.g., by the user device 150). Accordingly, the provider computing system 110 may include software and/or hardware capable of implementing a network-based or web-based application. For example, in some instances, the applications and/or executables include software such as HTML, XML, WML, SGML, PHP (Hypertext Preprocessor), CGI, and like languages.

In the latter instance, a user (e.g., a provider employee) may log onto or access the web-based interface before usage of the applications and/or executables. In this regard, the applications and/or executables may be supported by a separate computing system including one or more servers, processors, network interface, and so on, that transmit applications for use to the provider computing system 110.

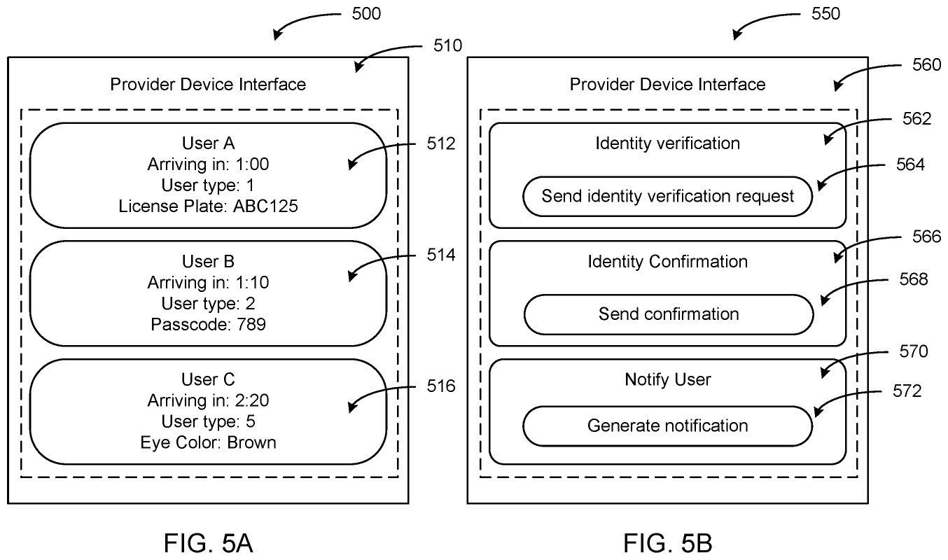

The provider executable 226 includes one or more executables for providing a provider application on the provider device(s) 115. In some implementations, the provider executable 226 includes an application such as a mobile application, a computer application, and the like. In some implementations, the provider executable 226 includes a web-based application such that the provider device(s) 115 may access the application via the network. The provider executable 226 include instructions to facilitate operations such as identifying the user 140 described herein. For example, the provider executable 226 may include instructions for generating an improved provider interface (described herein, below, with respect to FIGS. 5A and 5B). In some implementations, the provider executable 226 includes instructions for any other operation associated with the provider device(s) 115 described herein.

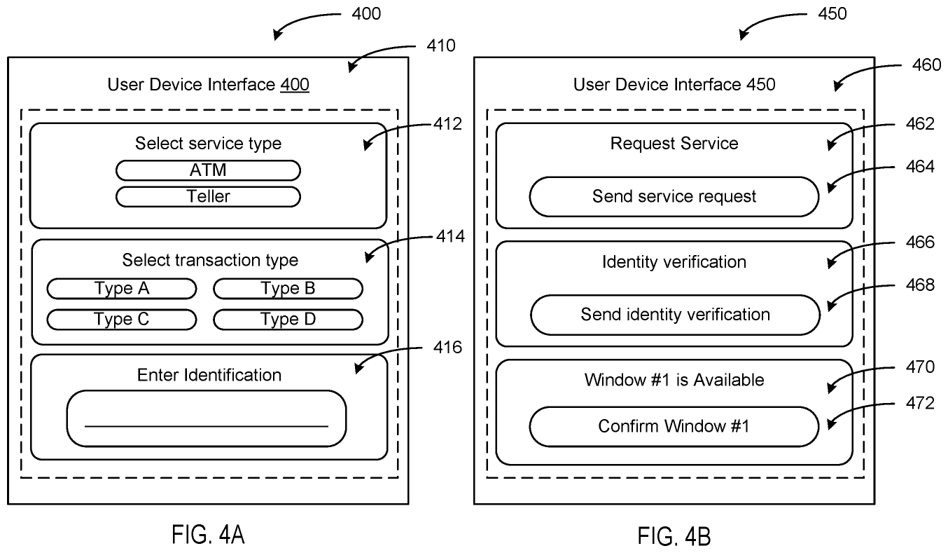

The user executable 228 includes one or more executables for providing a provider application on the user device(s) 150. In some implementations, the user executable 228 includes an application such as a mobile application (e.g., a mobile banking application, mobile wallet application, combination banking and wallet application, etc.), a computer application, and the like. In some implementations, the user executable 228 includes a web-based application such that the user device(s) 150 may access the application via the network. The user executable 228 include instructions to facilitate operations such as predictively queue up and determine transactions described herein. For example, the user executable 228 may include instructions for generating an improved user interface (described herein, below, with respect to FIGS. 4A and 4B). In some implementations, the user executable 228 includes instructions for any other operation associated with the user device(s) 150 described herein.

The provider device(s) 115 includes a processing circuit 230, an I/O circuit 236, and a database 238. In some implementations, the processing circuit 230, the I/O circuit 236, and the database 238 are the same or substantially similar to the processing circuit 202, the I/O circuit 208, and the database 222 of the provider computing system 110. For example, the processing circuit 230 may include a processor, shown as processor 232, and memory, shown as memory 234, that is the same as or substantially similar to the processor 204 and memory 206.

In some implementations, the database 238 stores the provider executable 226 such that the provider device(s) 115 is operable to execute the provider executable 226. For example, the provider device(s) 115 may execute the provider executable 226 to generate and/or display the provider interface (described herein, below).

The user device(s) 150 includes a processing circuit 240, an I/O circuit 246, and a database 248. In some implementations, the processing circuit 240, the I/O circuit 246, and the database 248 are the same or substantially similar to the processing circuit 202, the I/O circuit 208, and the database 2222 of the provider computing system 110. For example, the processing circuit 240 may include a processor, shown as processor 242, and memory, shown as memory 244, that is the same as or substantially similar to the processor 204 and memory 206.

In some implementations, the database 248 stores the user executable 228 such that the user device(s) 150 is operable to execute the user executable 228. For example, the user device(s) 150 may execute the user executable 228 to generate and/or display the user interface (described herein, below).

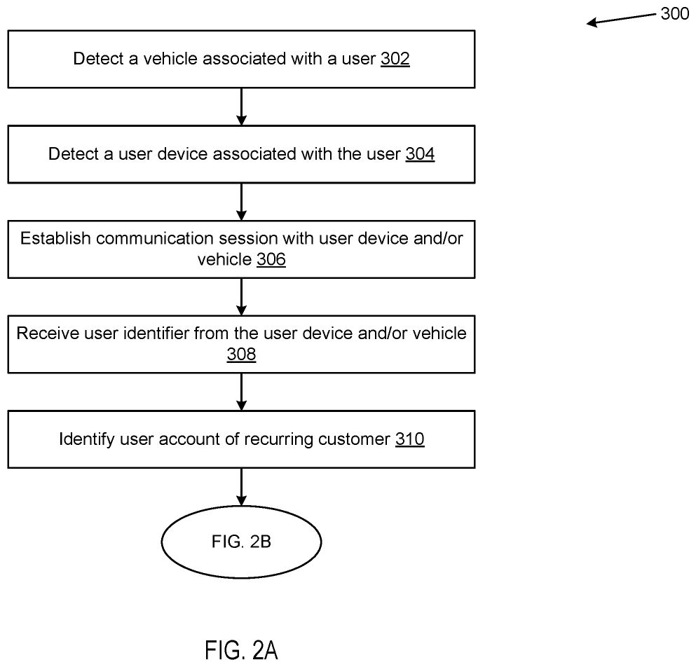

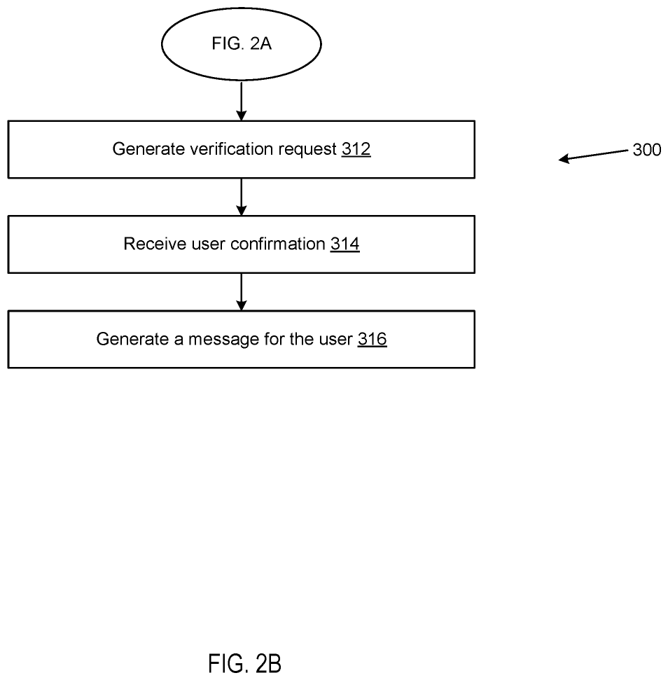

FIGS. 2A-2B depict a flow diagram of a method 300 of facilitating a transaction in the system 100 of FIGS. 1A and 1B, according to an example implementation. In some implementations, one or more of the computing systems of the system 100 may be configured to perform method 300. For example, the provider computing system 110, the provider device 115, and/or the user device 150 may be structured to perform, at least parts thereof, the method 300. In an example implementation, the provider computing system 110, the provider device 115, and/or the user device 150 may, alone or in combination with other devices, such as the cameras 120, sensor(s) 125, beacons 130, the I/O device(s) 135, and/or vehicle 145 may perform the method 300. In some implementations, the method 300 may include user inputs from a user (e.g., a provider employee) one or more user devices (such as devices of provider employees), another computing device on the network, and the like.

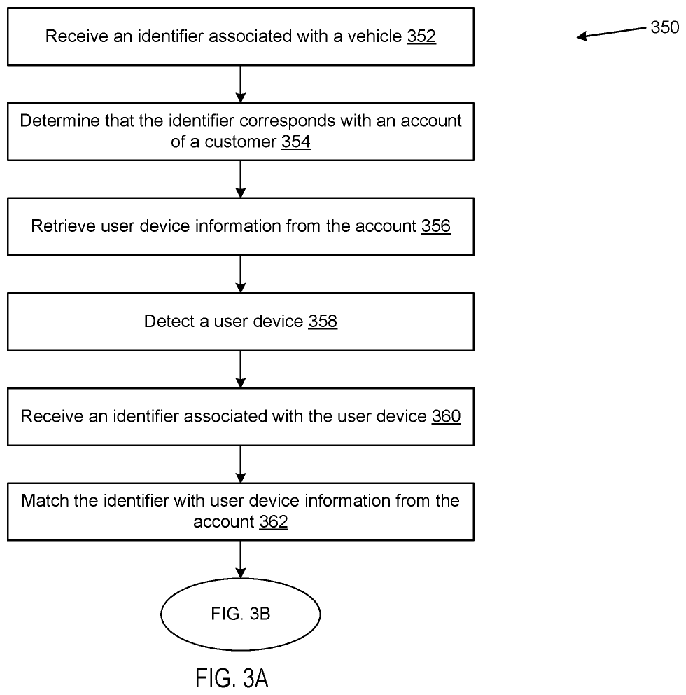

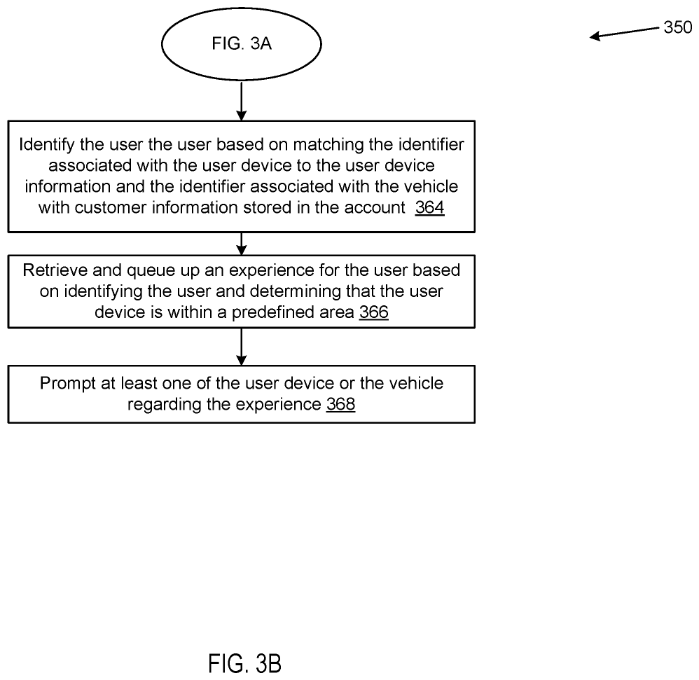

In an overview of method 300, at step 302, the provider computing system 110 detects a vehicle associated with the user. At step 304, the provider computing system 110 detects, from one or more wireless beacons, the user device 150 of the user 140. At step 306, the provider computing system 110 causes the one or more wireless beacons to establish a communication session with the user device. At step 308, the provider computing system 110 receives a user identifier from at least one of the user device 150 or the vehicle 145. At step 310, the provider computing system 110 identifies a user account based on the user identifier. At step 312, the provider computing system 110 generates a verification request. At step 314, the provider computing system 110 receives a user confirmation in response to the verification request. At step 316, the provider computing system 110 generates a message for the user. In some implementations, the steps of the method 300 may be performed in a different order than as shown in FIG. 3. For example, step 314 may be performed before step 312. In some implementations, the method 300 may include more or fewer steps than as shown in FIG. 3.

Referring to the method 300 in more detail, at step 302, the provider computing system 110 detects a vehicle 145 of the user. The vehicle 145 may be detected in a variety of ways. In one embodiment, detection is based on an explicit input from the user (e.g., via the vehicle 145 infotainment system, a garage clicker coupled to the vehicle 145, a voice command received by the vehicle 145 and transmitted over a network to the provider computing system 110, etc.). In another embodiment, the provider computing system 110 automatically detects the vehicle 145 without a user input. For example, the provider computing system 110 may wirelessly detect the vehicle 145 based on the vehicle 145 entering a geo-fenced area so that it is detected by receiving a signal from the vehicle (e.g., Bluetooth, etc.), receiving an indication of the vehicle 145 connecting or attempting to connect to a local area network associated with the provider computing system 110 (e.g., a branch local area network), and so on. As part of this detection, the provider computing system 110 may transmit a signal to the vehicle 145 to receive a vehicle identifier (e.g., a VIN, a software identifier for the vehicle 145, some other unique identifier, etc.). The vehicle identifier may be used by the provider computing system 110 to identify the vehicle 145, a user associated with the vehicle, and an associated account. Alternatively, the vehicle identifier may be detected automatically, such as based on a camera image of identifying vehicle information, such as a license plate. As another alternative, the vehicle may be identified from other vehicle identifying information, such as a noise profile associated with the vehicle (e.g., various noise profiles may be stored and compared against noise profiles detected), a three-dimensional image of the vehicle (e.g., a scan of the vehicle may be compared to stored scans of vehicles), unique features of the vehicle (e.g., bumper stickers, markings, etc.) that may be captured by a camera and compared against stored information, a combination thereof, and so on.

At step 304, the provider computing system 110 detects, from beacons 130, the user device 150 of the user 140. To detect the user device 150, the provider computing system 110 can cause the beacons 130 to ping the vicinity of the provider location 105 with requests to establish communication sessions. For example, the provider computing system 110 can cause the beacons 130 to enter into Bluetooth pairing mode and transmit pairing requests continuously to identify user devices 150 approaching the provider location 105. The provider computing system 110 can detect the user devices 150 that respond to the Bluetooth pairing requests from the beacons 130. In another example, the provider computing system 110 can cause the beacons 130 to configure a wireless network (e.g., Wi-Fi, or mesh network) at the provider location 105. The provider computing system 110 can cause the beacons 130 to transmit connection requests at the provider location 105. The provider computing system 110 can detect the user devices 150 that respond to the connection requests from the beacons 130. In yet another example, the provider computing system 110 can cause the beacons 130 to transmit pings to an ECU of vehicles 145 to identify the vehicle 145 to cross-reference the vehicle 145 to a known user 140. The provider computing system 110 can detect the vehicles 145 that respond to the pings from the beacons 130.

The provider computing system 110 can configure, based on the provider location 105, the distance and area in which the beacons 130 transmit the requests (e.g., Bluetooth pairing, Wi-Fi networks, ECU pings) to establish communication sessions. For example, if the provider location 105 is in a crowded area (e.g., shopping mall), the provider computing system 110 can configure the beacons 130 to transmit the requests within a subset (e.g., only inside the building) of the provider location 105. In another example, if the provider location 105 is in a spacious area (e.g., independent building on a side of a road), the provider computing system 110 can configure the beacons 130 to transmit the requests in the entire area of the provider location 105 (e.g., the building and the parking lot extending to the street). Such configurations of where to establish communications can advantageously and efficiently allocate computing resources since only areas likely to have the users 140 will be targeted with transmissions.

In some implementations, to detect the user device 150, the provider computing system 110 can cause the cameras 120 to scan the provider location 105 for the user 140, their vehicle 145, and/or their user devices 150. For example, the provider computing system 110 can cause the cameras 120 to generate images of people or objects approaching the provider location 105 (e.g., within a geo-fenced area). The provider computing system 110 can detect the user 140 by analyzing (e.g., facial recognition or retina scan) the images received from the cameras 120. In another example, the provider computing system 110 can cause the cameras 120 to generate images of vehicles 145 approaching the provider location 105. The provider computing system 110 can detect the vehicle 145 by identifying (e.g., shape of a vehicle) information from the images of the vehicle 145 received from the cameras 120. In yet another example, the provider computing system 110 can cause the cameras 120 to generate images of user devices 150 approaching the provider location 105. The provider computing system 110 can detect the user devices 150 by identifying (e.g., QR code displayed on a screen of the user device 150) the images of the user devices 150 received from the cameras 120.

The provider computing system 110 can configure, based on the provider location 105, the area in which to analyze images generated by the cameras 120. For example, if the provider location 105 is in a crowded area (e.g., shopping mall), the provider computing system 110 can capture and analyze images within a subset (e.g., only next to the building since that is where the likely customers are located) of the provider location 105. In another example, if the provider location 105 is in a spacious area (e.g., independent building on a side of a road), the provider computing system 110 can capture and analyze images in the entire predefined area of the provider location 105 (e.g., the building and the parking lot extending to the street since that is where the likely customers are located). Such configurations of where to capture and analyze images can advantageously and efficiently allocate computing resources since only areas likely to have the users 140 will be analyzed.

In some implementations, to detect the user device 150, the provider computing system 110 can cause the sensors 125 to detect the user 140, their vehicle 145, and/or their user devices 150. For example, the provider computing system 110 can detect a signal from the sensors 125 responsive to detecting movements of the user 140 or the vehicle 145 approaching the provider location 105. In another example, the provider computing system 110 can use the sensors 125 to detect that the user device 150 has entered a first geolocation area, where the geolocation area is associated with a physical location of the provider location 105. In yet another example, the provider computing system 110 can detect a signal from the sensors 125 responsive to detecting (e.g., NFC scan) the user devices 150 approaching the provider location 105.

The provider computing system 110 can configure, based on the provider location 105, the sensitivity of the sensors 125. For example, if the provider location 105 is in a crowded area (e.g., shopping mall), the provider computing system 110 can configure the sensors 125 with a low sensitivity (e.g., only detect movements near the building since that is where the likely customers are located). In another example, if the provider location 105 is in a spacious area (e.g., independent building on a side of a road), the provider computing system 110 can configure the sensors 125 with a high degree of sensitivity (e.g., the building and the parking lot extending to the street since that is where the likely customers are located). Such configurations of sensitivity to detect the user 140, the vehicle 145, and the user devices 150 can advantageously and efficiently allocate computing resources since only detections indicative of the 140 will be analyzed instead of excessive false detections of other people.

At step 304, the provider computing system 110 causes the beacons 130 to establish a communication session with the user device. For example, the provider computing system 110 can cause the beacons 130 to establish a Bluetooth connection with the user devices 150 that respond to the Bluetooth pairing requests from the beacons 130. In another example, the provider computing system 110 can cause the beacons 130 to establish a Wi-Fi connection with the user devices 150 that request to connect to the Wi-Fi network established by the beacons 130. In yet another example, the provider computing system 110 can cause the beacons 130 to establish a wireless connection with the vehicle 145 after the ECU of the vehicle 145 responds to the pings from the beacons 130.

At step 306, the provider computing system 110 receives a user identifier from the user device 150. The user identifier (e.g., username, numeric value, alpha value, alphanumeric value, etc.) corresponds to the user 140 and is configured to identify the user. The user identifier can be a unique identifier regarding the user 140. For example, the user identifier be an account number of an account of the user 140. The user identifier can be a numeric, alphanumeric, or other value for the user 140. In some implementations, the provider computing system 110 receives the token from the user device 150, and the token can include the user identifier. The provider computing system 110 can receive or identify the user identifier of the user 140.

The provider computing system 110 can receive the user identifier from the user device 150 via the network. For example, the provider computing system 110 can communicate with the user device 150. The provider computing system 110 can receive the user identifier from the vehicle 145 or the user device 150 that is a smartphone transmitting the user identifier to the provider computing system 110 via the network. The user device 150 can transmit its user identifier via a user session on the user device 150 with the provider computing system 110. The user session may be a user session on a mobile application, a vehicle-based application, and so on. The user session may include the user interface described herein, below with respect to FIG. 4. The user session may be configured and established by the user device 150 executing the user executable 136 to facilitate providing of the user identifier to the provider computing system 110. In some implementations, the provider computing system 110 may receive an indication that the user device 150 has executed the user executable 136. The vehicle 145 or the user device 150 can transmit the user identifier responsive to identifying that the vehicle 145 or the user device 150 is approaching the provider location 105. For example, the vehicle 145 or the user device 150 can use a GPS sensor to determine proximity to the provider location 105.

In some implementations, the provider computing system 110 can receive the user identifier from the cameras 120 or the sensors. For example, the user identifier may be identified from the user 140 (e.g., the user 140 is detected by a cameras 120). In another example, the provider computing system 110 can cause the cameras 120 to scan a license plate of the vehicle 145 or a screen of the user device 150. The provider computing system 110 can cause or request the cameras 120 to capture images of the vehicle 145. In another example, the cameras 120 can automatically scan or capture images of the vehicle 145 upon detecting a vehicle 145 driving up to the provider location 105. The cameras 120 can provide or transmit the images or scans to the provider computing system 110. The provider computing system 110 can receive the images from the cameras 120. The provider computing system 110 can apply image analysis techniques to extract the license plate of the vehicle 145 of the user 140 or to identify the user 140 in the images.

The provider computing system 110 can parse the images for the user identifier to detect/identify the user 140. For example, the provider computing system 110 can extract the license plate of the vehicle 145 from the image to identify the user identifier corresponding to the user 140. In another example, the provider computing system 110 can extract the user identifier attached to a windshield of the vehicle 145. In another example, the provider computing system 110 can extract the user identifier encoded into a QR code displayed by the user device 150.

In some implementations, the provider computing system 110 can receive the user identifier from the sensors 125. For example, the sensors 125 may detect that the user device 150 has entered a geolocation area of the provider location 105, where the geolocation area is associated with a physical location of the provider location 105. The sensors 125 can receive the user identifier in the form of NFC data received by sensors 125 interfacing with the user device 150.

In some implementations, the provider computing system 110 can receive the user identifier from the beacons 130 that establish connections with the vehicle 145 or the user devices 150 as described herein. For example, upon establishing the connection with the vehicle 145 or the user device 150, the beacons 130 can receive the user identifier from the vehicle 145 or the user device 150. The provider computing system 110 can receive the user identifier from the beacons 130 that connect to the user device 150. As described, herein, the beacons 130 can establish a connection with the user device 150. The beacons 130 can transmit a connection request or periodic ping to user devices 150 near the provider location 105. For example, the beacons 130 can detect or identify the vehicle 145 of the user 140 approaching the provider location 105. The beacons 130 can transmit a request to the user device 150 for the user identifier. The beacons 130 can extract the user identifier from the user device 150. For example, the beacons 130 can retrieve or extract the user identifier from data packets received from the vehicle 145 or the user devices 150. The beacons 130 can provide the user identifier to the provider computing system 110. In another example, the provider computing system 110 can receive the user identifier from the user device 150 that is a garage clicker in the vehicle 145 of the user 140, the garage clicker transmitting the user identifier to the beacons 130 via short-range communication protocols.

In some implementations, the provider computing system 110 receives the user identifier from the I/O devices 135. For example, the user 140 enters their user identifier into the I/O device 135, and the I/O device 135 transmits the user identifier to the provider computing system 110.

In some implementations, when the provider computing system 110 receives the user identifier, the provider computing system 110 automatically causes the user device 150 to enter a branch mode. The branch mode can include features specific to that branch. For example, the branch mode can cause the I/O devices 135 to display information about the branch (e.g., name or address, map of the location, etc.) and features or services available at the branch (e.g., deposits, withdrawals, loans, etc.). The branch mode may include a second user interface as shown and described herein below. Software for executing the branch mode may be stored by the provider computing system 110 and/or the user device 150. For example, the user executable 228 may include instructions for executing the branch mode. The branch mode may allow the user device 150 to interact directly with the components of the system 100 and/or facilitate identification of the user 140.

At step 308, the provider computing system 110 identifies the user account of the user 140. The provider computing system 110 can query or search the user identifier in the database 222. The provider computing system 110 can identify a user account of the user 140 by identifying that the received user identifier matches a user identifier of the user account of the user 140.

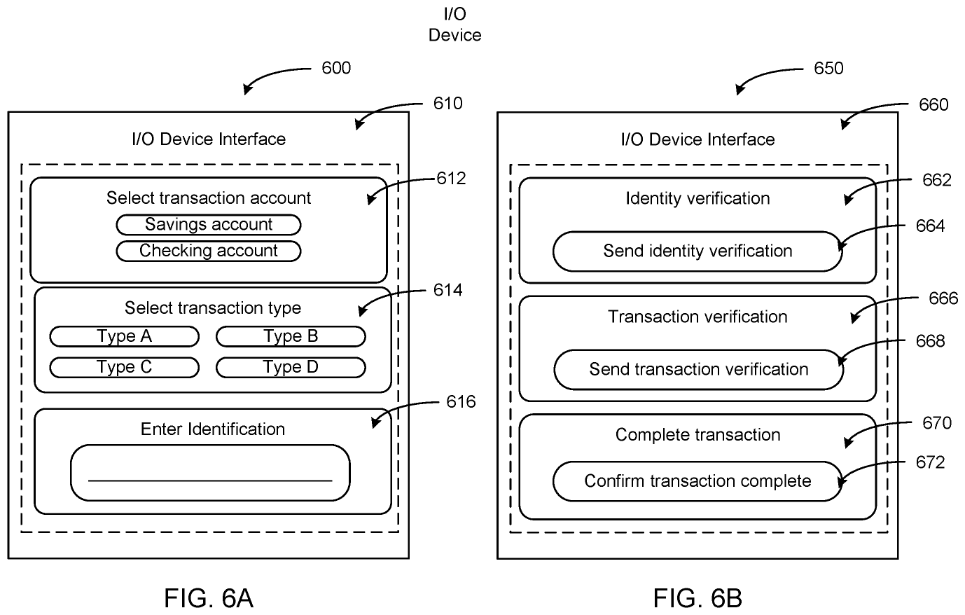

By identifying the user account, the provider computing system 110 can generate insights and analytics about the user's 140 interactions with the provider location 105. The provider computing system 110 can infer or determine the user's 140 favorite transactions based on historical interactions of the user 140 at the provider location 105. The provider computing system 110 can identify interactions and one or more associated transaction parameters, a transaction type, a transaction amount, and so on. For example, provider computing system 110 can monitor or identify which drive up tellers, lobby tellers, or ATMs the user identifier of the user 140 is associated with or frequently used. The provider computing system 110 can identify each provider location and associated activities of the user 140 based on the user identifiers detected at each location. For example, the provider computing system 110 can identify each provider location that the user 140 regularly visits, such as one near the user's 140 home to withdraw cash and a second location near the user's 140 place of work to deposit daily earnings or make change orders. In some implementations, the provider computing system 110 can identify that the user 140 is the recurring customer based on the user identifier identifying the user as a customer (i.e., a recurring customer) and/or based on a number of detections of the user device 150 at the provider location 105 satisfying a predetermined threshold (e.g., more than five visits indicate that the customer is a recurring customer). The provider computing system 110 can modify, based on identifying that the user 140 is the recurring customer, the message (as shown and described in FIGS. 4 and 6) for presentation to the user 140 at the provider location 105.

At step 310, the provider computing system 110 generates a verification request corresponding to the user account. For example, the provider computing system 110 can transmit a notification to the user device 150 to confirm an identity of the determined user. For example, the notification can be an OTP. In another example, the notification is an audio prompt sent to the user device 150 or the provider devices 115. In yet another example, the notification is a visual prompt requesting user confirmation. The visual prompt can be instructions, a text code, or a scannable code. The provider computing system 110 can transmit the notification via the communication session between the user devices 150 and any of the devices of the provider location 105.

At step 312, the provider computing system 110 receives a user confirmation. The provider computing system 110 can confirm the user 140. The provider computing system 110 can confirm the identification of the user 140. Responsive to receiving the confirmation from the user device 150, the provider computing system 110 may generate a notification indicating that the user identifier for the user account has been confirmed. In some implementations, the provider computing system 110 generates a message to confirm the user identifier of the user. For example, the provider computing system 110 can generate a message that indicates “this is the license plate # and car make/model that we noticed the last time you visited this branch. Would you like to use that inform as the identifier that going forward?” If the provider computing system 110 receives a confirmation of the user identifier, the provider computing system 110 can store the confirmed user identifier as a default user identifier for the user 140.

The user confirmation may include an indication that the user 140 approves the identification. The provider computing system 110 can receive the user confirmation responsive to the verification request. In another example, the authentication circuit 210 may authenticate a user, as described above. In an example implementation, the user 140 may provide the user confirmation to the provider computing system 110 via the user device 150. For example, the user confirmation may be provided by an input to a mobile application, input to a web-based application, a text message, and the like. The user confirmation may be received via the one or more beacons 130 and/or the one or more I/O device 135. For example, the confirmation may be provided by verbally via a microphone, a video capture, or other communication method.

In some implementations, the provider computing system 110 receives the user confirmation in the form of an audio input. For example, the user 140 may speak into a microphone and verbally provide the user confirmation. In yet another example, the user 140 may verbally provide a transaction ID or account PIN. In some implementations, the microphone included in the vehicle 145, the user device 150, the sensors 125, or the I/O devices 135. The provider computing system 110 receives the audio input from the microphone included in the vehicle 145, the user device 150, the sensors 125, or the I/O devices 135.

In some implementations, the user confirmation is received in the form of a one-time password (OTP). In some implementations, the OTP is provided to the user 140, via the user device 150. The OTP may be generated by the provider computing system 110 and/or the provider device 115 (e.g., using the authentication dataset 224). In some implementations, the OTP is automatically transmitted to the user device 150 when the provider computing system 110 identifies the user (e.g., the vehicle, the user device, etc.). In some implementations, the OTP is manually transmitted to the user device 150 by a provider employee using the provider device 115.

The provider computing system 110 can receive the OTP from the user device 150. In some implementations, the OTP is entered by the user 140 into the user interface of the vehicle 145, the I/O device 135 (e.g., ATM), and/or the user device 150. In some implementations, the OTP is provided by the user 140 to one or more of the provider employees using the provider devices 115. In some implementations, the OTP is entered by the user into the one or more I/O devices 135, such as a touchscreen device, a keyboard, a keypad, etc.

The provider computing system 110 can validate the OTP. For example, the provider computing system 110 can compare the received OTP to the transmitted OTP. If both OTPs match, then the provider computing system 110 can validate the user confirmation. If the OTPs do not match, then the provider computing system 110 can transmit a new OTP as described at step 310. Further, the provider computing system 110 may apply a timer such that the received OTP must be within a predefined amount of time of transmission in addition to matching the transmitted OTP as an added layer of security.

In some implementations, the user confirmation is received in the form of a communication from the user device 150. For example, a user may “tap” the user device 150 on a NFC device associated with the I/O device 135. In an example implementation, the “tap” may initiate a wireless communication between the user device 150 and the provider computing system 110. In other implementations, the user device 150 may additionally and/or alternatively establish communication with the provider device 115, and/or the I/O device 135. Once communication is established, the provider computing system 110 (e.g., the user device management circuit 214) may request the user device 150 to transmit the user confirmation.

In some implementations, the user confirmation is received in the form of a communication from the user device 150. For example, a user may scan a scannable code (e.g., a quick response code) using the cameras 120 of the user device 150. In some implementations, scanning the code may cause the user device 150 to initiate a wireless communication between the user device 150 and the provider computing system 110. In other implementations, the user device 150 may additionally and/or alternatively establish communication with the provider device 115 and/or the I/O devices 135. Once communication is established, the provider computing system 110 (e.g., the user device management circuit 214) may request the user device 150 to transmit the user confirmation.

At step 314, the provider computing system 110 generates a message for the user. The message can include instructions or notifications for the identified user. The message can include an indication of which provider device 115 or I/O device 135 the user 140 should approach. In some implementations, the message includes an indication of which provider employee will assist the user 140.

The provider computing system 110 can identify or recommend interactions for the user 140 based on the historical activities of the user 140 such that the experience is tailored/customized to the user. For example, the provider computing system 110 can suggest transactions that may be more convenient for the user 140 based on their prior activities and preferences. The provider computing system 110 can display the preferences in the user device 150 (e.g., via a provider institution mobile application, such as a mobile banking application). The user 140 can use the user device 150 to view or modify the preferences. For example, the user 140 can use the user device 150 to specify that they prefer interacting with a teller of the provider device 115. The provider computing system 110 can select, responsive to validating the user confirmation and based on the user account, the provider devices 115 or the I/O device 135 for interfacing with the user 140 to conduct the transaction. For example, the provider computing system 110 can identify that a preference of the user 140 of the user account is to use the provider devices 115 (e.g., user 140 prefers using an ATM). In another example, the provider computing system 110 can identify that a preference of the user 140 of the user account is to use the I/O devices 135 (e.g., user 140 prefers interacting with a teller). The provider computing system 110 can include an identifier of the selected provider devices 115 or the I/O device 135 for the user 140.

To select among provider devices 115 or the I/O device 135 for the user 140, the provider computing system 110 can evaluate the required functionality for the user 140 relative to a real-time status of tellers using the provider devices 115 and the status of the I/O devices 135. As described above, the provider team management circuit 220 may receive real-time status data from the provider device(s) 115, and the I/O device management circuit 218 may receive real-time status data from the I/O devices 135. For example, if the user 140 requests a change order, then the provider computing system 110 can direct the user 140 to the provider device 115 with the teller instead of an I/O device that provides pneumatic tubes of change (e.g., rolled coins in a change order are too heavy to travel over the tube). In another example, the provider computing system 110 can direct the user 140 to the fastest lane or even another branch of the provider if the queues are too long, if the current branch cannot handle the predicted transaction, a combination thereof, etc. While selecting among provider devices 115 or the I/O device 135 for the user 140, the provider computing system 110 can incentivize the user 140 to use an automated I/O device 135 (e.g., self-service drive up ATM) instead of the provider devices 115 (e.g., full service drive up teller).

The provider computing system 110 determines whether a teller using the provider device 115 is capable of servicing the user 140. The provider team management circuit 220 may determine, based on the real-time status data, a real time status for each of a plurality of provider employees. In some implementations, the provider team management circuit 220 may receive provider team member data including provider team member statistics. The provider team management circuit 220 may determine based on the provider team member statistics and/or the real time status of each provider employee, whether a provider employee is capable of servicing the user 140. For example, the provider team management circuit 220 may determine that a first provider employee is capable of servicing the user 140 if the first provider employee's real-time status indicates that the first provider employee is currently idle or will finish a different work event (e.g., assisting another customer, on break, starting a shift, and so on) within a predetermined time period. The time period may be based on one or more of the transaction type, an amount of time the user 140 has already been waiting, and/or other parameters associated with servicing the user 140. In some implementations, the provider team management circuit 220 may further determine that a first provider employee is capable of servicing the user 140 if the first provider employee's statistics (e.g., experience level, tendency to make mistakes, seniority level, and so on) are within a threshold amount associated with the user 140.

The provider computing system 110 determines whether the I/O devices 135 are capable of servicing the user 140. The I/O device management circuit 218 may determine, based on the real-time status data, a real time status for each of the I/O devices 135. In some implementations, the I/O device management circuit 218 may receive data and usage statistics from the I/O devices 135. The I/O device management circuit 218 may determine, based on the statistics and/or the real time status of each I/O device 135, whether the I/O device 135 is capable of servicing or receiving inputs from the user 140. For example, the I/O device management circuit 218 may determine that a first I/O device 135 is capable of servicing the user 140 if the first I/O device's real-time status indicates that the first I/O device 135 is currently idle or will finish a different user 140 within a predetermined time period. The time period may be based on one or more of the transaction type, an amount of time the user 140 has already been waiting, and/or other parameters associated with servicing the user 140. In some implementations, the I/O device management circuit 218 may further determine that a first I/O device 135 is capable of servicing the user 140 if the first I/O device's statistics (e.g., screen size, disability support, cash dispenser, and so on) are within a threshold amount associated with the user 140.

The provider computing system 110 can add the customer to a dynamic service queue for the provider devices 115 or the I/O devices 135. The dynamic service queue for provider devices 115 may be displayed on the provider device 115 (as described herein, below, with respect to FIG. 5). In some implementations, the provider device management circuit 212, the I/O device management circuit 218, and/or the provider team management circuit 220 may update the dynamic service queue with additional user identifiers of additional users 140. Accordingly the dynamic service queue may be advantageously automatically updated with new user identifiers as the provider computing system 110 assigns users 140 to the dynamic service queue. The users 140 may be positioned in the queue in an order based on a transaction type, an amount of time a user 140 has been waiting, and/or other parameters associated with the user 140. For example, a first type of user 140 may have a higher priority than a second type of user 140. Accordingly, a user identifier for a first user type may be positioned in a dynamic service queue before a second user identifier for a second user type. Additionally, a first user having a first user identifier arriving before a second user associated with a second user identifier may be positioned before the second user in the teller-specific dynamic service queue. In an example implementation, the provider computing system 110 is structured to consider multiple variables when ordering the users in the dynamic service queue.

If the provider device 115 is selected for the user 140, the provider computing system 110 can provide a service alert to the teller associated with the device 115. The provider computing system 110 may, at least partially, generate a notification for displaying on the provider device 115. In some implementations, the provider device 115, at least partially, generates the notification. The notification indicates that the user will arrive at the designated provider device 115.

In some implementations, the provider computing system 110 generates the message that includes a request for the user to provide secondary authentication. The secondary authentication may include one or more of a password, a PIN, an OTP, a biometric scan, an identification card, a picture of the user, a picture of the identification card, and/or other suitable identifying parameters. In some implementations, the secondary authentication may include a request for the user 140 to physically pass one or more identification documents (e.g., a driver's license, a passport, etc.) to a provider employee.

The provider computing system 110 can transmit the message to the user device 150. For example, the provider computing system 110 can transmit the message via the communication protocol. In some implementations, the provider computing system 110 can transmit the message to the provider devices 115. For example, the provider devices 115 can include a speaker that generates an audio signal identifying the selected provider devices 115 or the I/O device 135 for the user. In another example, the provider devices 115 can include a display that displays the selected provider devices 115 or the I/O device 135 for the user.

The provider computing system 110 can send the message via a mobile application notification (e.g., a “push notification”), a text message (e.g., SMS, MMS, and RCS), e-mail, and/or other suitable communication method. In some implementations, the provider computing system 110 can transmit the message to the provider device 115. In some implementations, the provider computing system 110 can transmit the message to the user device 150. In some implementations, the provider computing system 110 can transmit the message to the I/O device 135. In some implementations, the message can include information about transactions associated with the user 140, a network status of the session, or a summary of the user's 140 visit to the provider location 105.

Referring now to FIGS. 3A-3B, a flow diagram of a method 350 of identifying a recurring customer to quickly queue up a transaction is shown, according to an example embodiment. In some implementations, one or more of the computing systems of the system 100 may be configured to perform method 300. For example, the provider computing system 110, the provider device 115, and/or the user device 150 may be structured to perform the method 300. In an example implementation, the provider computing system 110, the provider device 115, and/or the user device 150 may, alone or in combination with other devices, such as the cameras 120, sensor(s) 125, beacons 130, the I/O device(s) 135, and/or vehicle 145 may perform the method 300.

The method includes the provider institution computing system 110 receiving an identifier associated with a vehicle at step 352. Detecting the vehicle 145 and receiving an identifier associated with the vehicle may be similar to step 302 of method 300. For example, the identifier may include a license plate value, and the provider institution computing system 110 may transmit an instruction to a camera at the provider location to scan the vehicle. The camera obtains an image of the vehicle based on the scan and transmits the image to the provider institution computing system 110. Alternatively, the processing/analysis occurs locally at the provider branch location. The image is analyzed by the provider institution computing system 110 to extract the license plate value. Subsequently, the provider institution computing system 110 matches the license plate value to a stored license plate value regarding the vehicle in the account of the user.

At step 354, the provider institution computing system 110 determines that the identifier corresponds with an account of a customer. At step 356, the provider institution computing system 110 retrieves user device information associated with the customer stored in the account based identifying the account. For example, user device identifiers (e.g., serial number, IP addresses, etc.) associated with the user device and the user may be stored in an account associated with the user.

At step 358, a user device is detected. For example, the provider institution 110 may detect a user device at a provider location (e.g., a branch location) as described above with respect to step 304. At step 360, the provider institution computing system 110 receives an identifier associated with the user device based on detecting the user device. The user device identifier may be a unique identifier for the user device, such as a serial number, IP or network address, etc. At step 362, the provider institution computing system 110 matches the identifier associated with the user device to the user device information associated with the customer stored in the account. The provider institution computing system 110 may receive multiple user device identifiers from the detection and may require that a threshold number of identifiers match with user device identifiers in the account (e.g., an IP address and a serial number match the IP address and serial number on file). In this regard, the provider institution computing system 110 may require that at least one identifier match at least one user device identifier stored in the account.

At step 364, the provider institution computing system 110 identifies the user based on matching the identifier associated with the user device to the user device information and the identifier associated with the vehicle with customer information stored in the account (i.e., two-factor identification). At this point, the provider institution computing system 110 recognizes the user as a repeat customer.

At step 366, the provider institution computing system 110 retrieves and queues up an experience for the user based on identifying the user and determining that the user device is within a predefined area. For example, the wireless beacons may have a predefined range such that detecting the user device and vehicle within that range corresponds with the user being in the predefined area.

Based on the identifying the customer as a repeat customer, the provider institution 110 may retrieve and queue up an experience custom to the identified repeat customer. For example, based on the time of day, day of the week, day of the month, a combination thereof, etc., the provider institution computing system 110 may identify similar experiences, such as similar transactions, performed by the identified repeat customer at this time and select the most common performed transaction as the retrieved experience. As another example, based on the provider location (e.g., location A versus location B), the provider institution computing system 110 may identify experiences (e.g., transactions) performed by the repeat customer at this location and retrieve and queue up those experiences for the repeat customer. As another example, time and location factors may be used by the provider institution computing system. As still another example, the provider institution computing system 110 may utilize machine learning, artificial intelligence, etc. to infer the identified repeat customer's favorite transactions (e.g., experiences) based on what they've historically done at the branch location drive-up teller, lobby teller, and/or ATMs. This determination may be location-specific if the identified repeat customer visits multiple locations (e.g., Branch A near customer's home: withdraw cash while Branch B near customer's small biz: deposit daily earnings or make change orders).

At step 368, the providing institution computing system prompts at least one of the user device or the vehicle regarding the experience. For example, the determined transaction (e.g., a withdrawal of $X) may be provided to the user's user device 150 (e.g., via email, as a stored message within a provider application for accessing by the customer, etc.). Alternatively or additionally, the determined transaction may be provided to the vehicle 145 of the user (e.g., via an infotainment center for display). As an example, the provider institution computing system 110 may identify a network address associated with the vehicle 145 (e.g., which may be stored in the account of the user) and based on the vehicle 145 being within a predefined area (i.e., a range associated with a wireless communication session, such as Bluetooth or Wi-Fi range), the provider institution computing system 110 provides the prompt to an input/output device of the vehicle based on the network address. The prompt regarding the experience may include a request for additional authentication information.

In some embodiments, the prompt includes a request for a credential. The prompt may be provided to at least one of the vehicle 145 and the user device 150. A device at the provider location (e.g., ATM, terminal, etc.) may receive the credential from at least one of the vehicle 145 or the user device 150. In one embodiment, the credential is provided via a short range wireless communication from the user device to a device associated with a provider institution (e.g., a NFC tap of the credential to an ATM). The credential may be a passcode, a specific value, etc. that is embodied in a NFC data packet that is transmittable via a tap from the user device 150 to a NFC terminal for verification. The provider institution computing system 110 may subsequently verify the credential based on the credential being received within a predefined amount of time following the prompt and matching the credential on file and/or provided to the user device 150 for transmission. Based on the verification, the identified repeat customer may proceed with a transaction without additional authentication information.

In some embodiments, the prompt for additional authentication information may be provided to the user device 150 instead or in addition to the vehicle 145. The additional authentication information may be a OTP, PIN, other passcode, biometric, a combination thereof, etc. The provider institution computing system 110 may receive the authentication information from the user device 150, compare the received authentication information to information stored in the account of the user, and based on a match, enable a transaction or a certain transaction at the provider location (e.g., a withdrawal).

In some embodiments, the provider institution computing system 110 may provide a command to sensors, cameras, etc. at one or more associated provider locations to monitor various areas. As a result, the provider institution computing system 110 may receive usage information (e.g., which drive-up lanes are occupied, average wait times, ATM availability, and so on.). Accordingly, the provider institution computing system 110 may provide a message to a display device of the provider institution (e.g., digital sign) indicating a lane to use for the vehicle 145 at the provider institution based on the monitored area.

One example of operation, with respect to a prestaged transaction, may be described as follows. The repeat customer 140 prestages a transaction on a provider institution mobile application installed on the user device 150 (e.g., the customer selects one or more favorite transactions). The customer 140 may click a submit button or other indicator to submit the transaction and indicate that the customer is traveling to a certain provider location (using GPS of the mobile device, a time estimate may be determined by the computing system 110 for when they will arrive). In another embodiment, the customer may provide this information (favorite transaction) via the vehicle 145 (e.g., via an application provide in a car infotainment system). As a specific example, the customer may use voice, gestures, a combination thereof to provide a favorite transaction (e.g., three fingers up may signify a thirty-dollar withdrawal, the transaction may be said aloud verbally, etc.) to prestage the transaction without the user manually entering it via the user device 150 or vehicle 145. Cameras or other sensors (e.g., audio sensors on the user device 150 or vehicle 145) may capture the instructions.

The arrival of the customer may be detected. For, example, a camera at the provider institution location may identify a license plate, a car make/model, a customer (e.g., biometric recognition), a GPS of phone or of car infotainment system, a Bluetooth of phone or car, a NFC communication with the car or vehicle, etc. Alternatively, the detection by the computing system 110 may be based on an explicit input. For example, the customer may actuate their garage clicker (e.g., customer's own handheld clicker or built-in clicker in car) that transmits a code previously stored by the clicker to the provider location and subsequently to the provider institution computing system 110. As another example, the provider institution may issue a fob that has a plurality of buttons for favorite transactions. The fob may communicate with the provider location and, in turn, provider computing system 110 via NFC, Bluetooth, Wi-Fi, a combination thereof, etc. As yet another example, the customer may check-in via the provider institution application on the user device 150 and/or via the vehicle 145.

Upon arrival, the provider institution computing system 110 may direct the customer (e.g., to an available drive-up lane). For example, if the customer is doing a change order, the customer may be directed to the drive-up lane that is at a drive-up teller window, and not a lane that uses a pneumatic tube (the rolled coins in a change order are too heavy to travel over the tube). As another example, the provider institution computing system 110 may direct the customer to the fastest lane (or even another branch if drive-up queues at the instant branch are too long). The provider institution computing system 110 may provide one or more incentives to use drive-up ATM (self-service) instead of drive-up teller (full service). For example, rewards (e.g., monetary, etc.) may be provisioned to the provider institution application on the user device 150 if the user takes the incentive.

The provider institution computing system 110 authenticates the repeat customer. As described herein, authentication may be via a one-time passcode, a push notification, a connection to car infotainment systems, a voiceprint, use of the provider institution mobile application on the user device 150 (e.g., authenticate using built-in biometrics on the phone). Based on the authentication, the provider institution computing system 110 may alert a teller so the teller can perform tasks to speed up the customer's drive-up visit. The customer may perform their transaction. The session is ended, and the customer gets notification containing a summary of the visit (e.g., a summary sent to their user device 150).

As another example of operation, without a prestaged transaction, the same general operation may be apply except that the provider institution computing system 110 may predictively determine an experience (e.g., a transaction) for the identified and authenticated repeat customer. In which case, the provider institution computing system 110 may provide a notification to a provider location employee to queue up that transaction. As a specific example, the provider institution computing system 110 may transmit a notification to an ATM to queue up the transaction (e.g., a withdrawal) such that as soon as at least one of the customer device 150 or vehicle 145 are detect, the ATM is unlocked and the user may only need to enter a PIN or other passcode (or pass a credential via a NFC tap with the ATM). Subsequent to validating this information, the ATM dispenses the desired amount from the desired account of the customer.

In each situation (prestage versus predicting a transaction/experience), the customer experience may be lessened in time compared to typical experiences, loads on provider location devices (e.g., ATMs) may be decreased, and an overall customer experience improved. Moreover, these operations transform conventional operations in an atypical way to apply identification and verification processes quickly and accurately so that the time for a repeat customer to perform a transaction is less than if they were not in place. These process are not conventional due to the coordination of various computing devices to exchange certain information quickly to identify and authenticate the repeat customer.

FIG. 4A is an illustration of some aspects of a provider device interface 400 showing interactive icons, according to an example implementation. The provider device interface 400 includes a first interface feature 410. As shown in FIG. 4A, the first interface feature 410 includes one or more interactive icons shown as a first icon 412, a second icon 414, and a third icon 416. It should be understood that the first interface feature 410 may include more or fewer interactive icons than as shown in FIG. 4A. In some implementations, the first interface feature 410 is displayed when the user device 150 is proximate to the provider location 105.

In some implementations, each of the interactive icons (e.g., the first icon 412, the second icon 414, and the third icon 416) depict user options. The first icon 412 depicts a first set of user options shown as “Select service type”, from which a user 140 can select between an ATM (e.g., I/O device 135) and the “Teller” (e.g., provider device 115). The second icon 414 depicts a second set of user options shown as “Select transaction type”, from which the user 140 can select among “Type A”, “Type B”, “Type C”, or “Type D”. The third icon 416 depicts a second set of user options shown as “enter identification”, from which the user 140 can input identification information such as a password or PIN.

FIG. 4B is an illustration of some aspects of the user device interface 350, according to an example implementation. The user device interface 450 includes a second interface feature 460. The second interface feature 460 may include an interface for the user 140 to identify themselves. As shown in FIG. 4B, the second interface feature 460 includes one or more interactive features shown as a first feature 462, a second feature 466, and a third feature 470. It should be understood that the second interface feature 460 may include more or fewer interactive features than as shown in FIG. 4B.

The first feature 462 may include a first interactive feature 464. The first feature 462 may enable depict information related to requesting services from the provider location 105. In some implementations, the user 140 may interact with the first interactive feature 464 to cause the user device 150 to display and/or transmit a request for services along with a user identifier of the user. For example, the user identifier can include an account number, a transaction type, or name of the user 140.

The second feature 466 may include a second interactive feature 468. The second feature 466 may depict information related to verifying an identity of the user device 150 and/or an identity of a user associated with the user device 150. For example, the second feature 466 may be associated with options that the user 140 has pre-approved for verifying the user's identity, such as an identity token (described herein, above). The user 140 may interact with the second interactive feature 468 to cause the user device 150 to capture and/or transmit the identity token. In an example implementation, the second feature 466 may be inactive until a provider employee sends a request for identity verification. In some implementations, the second feature 466 is always active. When the second feature 466 is active, a user may select the second feature 466 to input and/or send the identity verification (e.g., identity token). In some implementations, selecting the second feature 466 may cause the user device 150 to capture a voice recording, capture a picture, receive a user input (e.g., a password, an OTP, and the like) or other data related to the identity verification. In some implementations, selecting the second feature 466 may cause the user device 150 to transmit the identity verification to the provider computing system 110. In some implementations, selecting the second interactive feature 468 causes the user device 150 to respond with an OTP from the provider device 115 and provide the OTP to the provider computing system 110 or the provider device 115.

The third feature 470 may include a third interactive feature 472. The third feature 470 may depict information related to a transaction for the user 140. For example, the third feature 470 may depict a location or identifier of a provider device 115 or I/O device 135 for the user 140 to use to complete the transaction.

FIG. 5A is an illustration of some aspects of a provider device interface 500 showing interactive icons, according to an example implementation. The provider device interface 500 includes a first interface feature 510. The first interface feature 510 may include information about users 140 arriving at the provider location 105. As shown in FIG. 5A, the first interface feature 510 includes one or more interactive icons shown as a first icon 512, a second icon 514, and a third icon 516. It should be understood that the first interface feature 510 may include more or fewer interactive icons than as shown in FIG. 5A.

In some implementations, each of the interactive icons (e.g., the first icon 512, the second icon 514, and the third icon 516) depict information about the users 140 to help an employee using the provider device 115 to identify the repeat users 140. For example, each of the interactive icons can display a name, an arrival time, a user type, or an identifying feature (e.g., license plate of their vehicle, a predetermined passcode, or a physical characteristic of the user 140).

FIG. 5B is an illustration of some aspects of a provider device interface 550, according to an example implementation. The provider device interface 550 includes a second interface feature 560. The second interface feature 560 may include an interface for facilitating a transaction. As shown in FIG. 5B, the second interface feature 560 includes one or more interactive features shown as a first feature 562, a second feature 566, and a third feature 470. It should be understood that the second interface feature 560 may include more or fewer interactive features than as shown in FIG. 5B.

The first feature 562 may include a first interactive feature 564. The first feature 462 may depict information related to requesting an identity of the user device 150 and/or an identity of the user 140 associated with the user device 150. For example, selection of the first interactive feature 564 can cause the provider computing system 110 to generate an OTP and transmit the OTP to the user device 150.

The second feature 566 may include a second interactive feature 568. The second feature 566 may depict information related to confirming the identity of the user 140. For example, the second interactive feature 468 may be selected to indicate that the user 140 provided the correct OTP.

The third feature 570 may include a third interactive feature 572. The third feature 570 may depict information related to notifying the user about a transaction. Selection of the third interactive feature 572 may cause the provider device 115 to send the user device 150 steps or information for the transaction. For example, the notification can identify an ATM or teller window for the user 140 to approach to complete the transaction.

FIG. 6A is an illustration of some aspects of an I/O device interface 600 showing interactive icons, according to an example implementation. The I/O device interface 600 includes a first interface feature 610. As shown in FIG. 6A, the first interface feature 610 includes one or more interactive icons shown as a first icon 612, a second icon 614, and a third icon 616. It should be understood that the first interface feature 610 may include more or fewer interactive icons than as shown in FIG. 6A. In some implementations, the first interface feature 610 is displayed when the user device 150 is proximate to the I/O device 135.

In some implementations, each of the interactive icons (e.g., the first icon 612, the second icon 614, and the third icon 616) depict user options. The first icon 612 depicts a first set of user options shown as “Select transaction account”, from which a user 140 can select between their accounts administered by the provider location 105. The second icon 614 depicts a second set of user options shown as “Select transaction type”, from which the user 140 can select among “Type A”, “Type B”, “Type C”, or “Type D”. The third icon 616 depicts a second set of user options shown as “enter identification”, from which the user 140 can input identification information such as a password or PIN.

FIG. 6B is an illustration of some aspects of the I/O device interface 650, according to an example implementation. The I/O device interface 650 includes a second interface feature 560. The second interface feature 660 may include an interface for the user 140 to identify themselves. As shown in FIG. 6B, the second interface feature 660 includes one or more interactive features shown as a first feature 662, a second feature 666, and a third feature 670. It should be understood that the second interface feature 660 may include more or fewer interactive features than as shown in FIG. 6B.

The first feature 662 may include a first interactive feature 664. The first feature 662 may enable depict information related to requesting services from the provider location 105. In some implementations, the user 140 may interact with the first interactive feature 664 to cause the I/O device 135 to display and/or transmit a request for services along with a user identifier of the user. For example, the user identifier can include an account number, a transaction type, or name of the user 140.

The second feature 666 may include a second interactive feature 668. The second feature 666 may depict information related to verifying an identity of the user device 150 and/or an identity of a user associated with the user device 150. For example, the second feature 666 may be associated with options that the user 140 has pre-approved for verifying the user's identity, such as an identity token (described herein, above). The user 140 may interact with the second interactive feature 668 to cause the I/O device 135 to capture and/or transmit the identity token or other identification information. In an example implementation, the second feature 666 may be inactive until a provider employee sends a request for identity verification. In some implementations, the second feature 666 is always active. When the second feature 666 is active, a user may select the second feature 666 to input and/or send the identity verification (e.g., identity token). In some implementations, selecting the second feature 666 may cause the I/O device 135 to capture a voice recording, capture a picture, receive a user input (e.g., a password, an OTP, and the like) or other data related to the identity verification. In some implementations, selecting the second feature 666 may cause the user device 150 to transmit the identity verification to the provider computing system 110. In some implementations, selecting the second interactive feature 668 causes the user device 150 to respond with an OTP from the provider device 115 and provide the OTP to the provider computing system 110 or the provider device 115.

The third feature 670 may include a third interactive feature 672. The third feature 670 may depict information related to a transaction for the user 140. For example, the third feature 670 may depict a location or identifier of a provider device 115 or I/O device 135 for the user 140 to use to complete the transaction.

FIG. 7 is a component diagram of an example computing system suitable for use in the various implementations described herein, according to an example implementation. For example, the computing system 700 may implement the provider computing system 110, the provider devices 115, the cameras 120, the sensors 125, the beacons 130, the I/O devices 135, the vehicles 145, the user device 150, and/or various other example systems and devices described in the present disclosure.

The computing system 700 includes a bus 702 or other communication component for communicating information and a processor 704 coupled to the bus 702 for processing information. The computing system 700 also includes main memory 706, such as a random access memory (RAM) or other dynamic storage device, coupled to the bus 702 for storing information, and instructions to be executed by the processor 704. Main memory 706 can also be used for storing position information, temporary variables, or other intermediate information during execution of instructions by the processor 704. The computing system 700 may further include a read only memory (ROM) 708 or other static storage device coupled to the bus 702 for storing static information and instructions for the processor 704. A storage device 710, such as a solid state device, magnetic disk or optical disk, is coupled to the bus 702 for persistently storing information and instructions.

The computing system 700 may be coupled via the bus 702 to a display 714, such as a liquid crystal display, or active matrix display, for displaying information to a user. An input device 712, such as a keyboard including alphanumeric and other keys, may be coupled to the bus 702 for communicating information, and command selections to the processor 704. In another implementation, the input device 712 has a touch screen display. The input device 712 can include any type of biometric sensor, a cursor control, such as a mouse, a trackball, or cursor direction keys, for communicating direction information and command selections to the processor 704 and for controlling cursor movement on the display 714.

In some implementations, the computing system 700 may include a communications adapter 716, such as a networking adapter. Communications adapter 716 may be coupled to bus 702 and may be configured to enable communications with a computing or communications network and/or other computing systems. In various illustrative implementations, any type of networking configuration may be achieved using communications adapter 716, such as wired (e.g., via Ethernet), wireless (e.g., via Wi-Fi, Bluetooth), satellite (e.g., via GPS) pre-configured, ad-hoc, LAN, WAN, and the like.

According to various implementations, the processes that effectuate illustrative implementations that are described herein can be achieved by the computing system 700 in response to the processor 704 executing an implementation of instructions contained in main memory 706. Such instructions can be read into main memory 706 from another computer-readable medium, such as the storage device 710. Execution of the implementation of instructions contained in main memory 706 causes the computing system 700 to perform the illustrative processes described herein. One or more processors in a multi-processing implementation may also be employed to execute the instructions contained in main memory 706. In alternative implementations, hard-wired circuitry may be used in place of or in combination with software instructions to implement illustrative implementations. Thus, implementations are not limited to any specific combination of hardware circuitry and software.

The implementations described herein have been described with reference to drawings. The drawings illustrate certain details of specific implementations that implement the systems, methods and programs described herein. However, describing the implementations with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor which, in some example implementations, may execute instructions stored, or otherwise accessed, via different areas of memory). Alternatively or additionally, the one or more processors may be structured to perform or otherwise execute certain operations independent of one or more co-processors. In other example implementations, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, and quad core processor), microprocessor, etc. In some implementations, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the implementations might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard discs, optical discs, etc. In other implementations, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes and omissions may be made in the design, operating conditions and implementation of the implementations without departing from the scope of the present disclosure as expressed in the appended claims.

1. A system comprising:
at least one processing circuit comprising at least one processor coupled to at least one memory device, the at least one processing circuit configured to:
identify, based on a provider location, a designated provider location area in which one or more wireless beacons associated with the designated provider location area can transmit a request to establish a communication session;
configure, based on the designated provider location area, a sensitivity of a sensor;
receive identification information regarding a vehicle associated with a user from the sensor corresponding to the designated provider location area;
detect the vehicle associated with the user in the designated provider location area based on the identification information;
detect, from the one or more wireless beacons, a user device in the designated provider location area associated with the user;
transmit, via the one or more wireless beacons, the request to establish the communication session with the user device within the designated provider location area;
cause the one or more wireless beacons to establish the communication session with the user device based on the user device being within the designated provider location area;
receive, from the user device via the communication session, a user identifier corresponding to the user;
cause, responsive to receiving the user identifier, the user device to enter a branch mode comprising a branch mode user interface;
identify, based on the user identifier, a user account of the user, wherein the user account of the user indicates that the user is a recurring customer;
generate a verification request corresponding to the user account of the user;
transmit, via the communication session, the verification request to the user device of the user, the verification request displayed via the branch mode user interface;
receive, from the user device via the branch mode user interface and the communication session, a user confirmation responsive to the verification request;
identify, responsive to receiving the user confirmation, at least one recommended transaction for the user, the at least one recommended transaction based on historical interactions of the user at the provider location;
identify at least one provider device at the provider location with functionality capable of assisting with the at least one recommended transaction;
receive real-time status data associated with the at least one provider device;
determine a real-time status of the at least one provider device based on the real-time status data;
based on the real-time status of the at least one provider device indicating that the at least one provider device is available, select the at least one provider device for the at least one recommended transaction; and
generate, responsive to the selection of the at least one provider device, a message based on the historical interactions of the user at the provider location for presentation to the user, the message comprising the at least one recommended transaction and the at least one provider device.

2. The system of claim 1, wherein the at least one processing circuit is further configured to:
detect, from the one or more wireless beacons, a location associated with at least one of the vehicle or the user device associated with the user;
identify that the user is the recurring customer based on a number of detections of the user device at the location satisfying a predetermined threshold; and
modify, based on identifying that the user is the recurring customer, the message for presentation to the user.

3. The system of claim 1, wherein the at least one processing circuit is further configured to transmit, to the user device via the communication session, a notification to confirm the user identifier.

4. The system of claim 1, wherein the at least one processing circuit is further configured to transmit the message to the user device via the communication session.

5. The system of claim 1, wherein the at least one processing circuit is further configured to:
cause, one or more sensors, to capture information from the user device; and
identify, based on the information, the user identifier corresponding to the user.

6. (canceled)

7. The system of claim 1, wherein the at least one processing circuit is further configured to transmit the message to the user device of the user.

8. The system of claim 1, wherein the message is a first message, and wherein the at least one processing circuit is further configured to:
select, responsive to validating the user confirmation and based on the user account, an interface device of a plurality of interface devices for interfacing with the user; and
generate, responsive to validating the user confirmation, a second message identifying the interface device to the user.

9. A method, comprising:
identifying, by a processing circuit and based on a provider location, a designated provider location area in which one or more wireless beacons associated with the designated provider location area can transmit a request to establish a communication session;
configuring, by the processing circuit, based on the designated provider location area, a sensitivity of a sensor;
receiving, by the processing circuit, identification information regarding a vehicle associated with a user from the sensor corresponding to the designated provider location area;
detecting, by the processing circuit, the vehicle associated with the user in the designated provider location area based on the identification information;
in response to detecting the vehicle, detecting, by the processing circuit, from the one or more wireless beacons, a user device in the designated provider location area associated with the user;
transmitting, by the processing circuit, the request to establish the communication session with the user device within the designated provider location area;
causing, by the processing circuit, the one or more wireless beacons to establish the communication session with the user device based on the user device being within the designated provider location area;
receiving, by the processing circuit and from the user device via the communication session, a user identifier corresponding to the user;
causing, by the processing circuit and responsive to receiving the user identifier, the user device to enter a branch mode comprising a branch mode user interface;
identifying, by the processing circuit, based on the user identifier, a user account of the user, wherein the user account of the user indicates that the user is a recurring customer;
generating, by the processing circuit, a verification request corresponding to the user account of the user;
transmitting, by the processing circuit via the communication session, the verification request to the user device of the user, the verification request displayed via the branch mode user interface;
receiving, by the processing circuit from the user device via the branch mode user interface and the communication session, a user confirmation responsive to the verification request;
identifying, by the processing circuit and responsive to receiving the user confirmation, at least one recommended transaction for the user, the at least one recommended transaction based on historical interactions of the user at the provider location;
identifying, by the processing circuit, at least one provider device at the provider location with functionality capable of assisting with the at least one recommended transaction;
receiving, by the processing circuit, real-time status data associated with the at least one provider device;
determining, by the processing circuit, a real-time status of the at least one provider device based on the real-time status data;
based on the real-time status of the at least one provider device indicating that the at least one provider device is available, selecting, by the processing circuit, the at least one provider device for the at least one recommended transaction; and
generating, by the processing circuit and responsive to the selection of the at least one provider device, a message based on the historical interactions of the user at the provider location for presentation to the user, the message comprising the at least one recommended transaction and the selected at least one provider device.

10. The method of claim 9, further comprising:
detecting, by the processing circuit, from the one or more wireless beacons, a location associated with detection of the user device of the user;
identifying, by the processing circuit, that the user is the recurring customer based on a number of detections of the user device at the location satisfying a predetermined threshold; and
modifying, by the processing circuit, based on identifying that the user is the recurring customer, the message for presentation to the user.

11. The method of claim 9, further comprising transmitting, by the processing circuit to the user device via the communication session, a notification to confirm the user identifier.

12. The method of claim 9, further comprising transmitting, by the processing circuit, the message to the user device via the communication session.

13. The method of claim 9, further comprising:
causing, by the processing circuit, the sensor to capture information from the user device; and
identifying, by the processing circuit and based on the information, the user identifier corresponding to the user.

14. The method of claim 9, wherein the message is a first message, and the method further comprises:
selecting, by the processing circuit, responsive to validating the user confirmation and based on the user account, an interface device of a plurality of interface devices for interfacing with the user; and
generating, by the processing circuit, responsive to validating the user confirmation, a second message identifying the interface device to the user.

15. A non-transitory computer-readable medium storing instructions thereon that, when executed by a processor, causes operations comprising:
identifying, based on a location of a provider institution, a designated provider location area in which one or more wireless beacons associated with the designated provider location area can transmit a request to establish a communication session;
configuring, based on the designated provider location area, a sensitivity of a sensor;
receiving an identifier associated with a vehicle associated with a user from the sensor corresponding to the designated provider location area;
detecting the vehicle associated with the user in the designated provider location area based on the identifier;
determining that the identifier corresponds with an account of the user;
retrieving user device information associated with the user stored in the account;
detecting, via the one or more wireless beacons, a user device in the designated provider location area associated with the user;
transmitting the request to establish the communication session with the user device;
establishing the communication session with the user device based on the user device being within the designated provider location area a predefined area;
receiving an identifier associated with the user device via the communication session;
causing, responsive to receiving the identifier associated with the user device, the user device to enter a branch mode comprising a branch mode user interface;
matching the identifier associated with the user device to user device information associated with the user stored in the account;
identifying the user based on matching the identifier associated with the user device to the user device information and the identifier associated with the vehicle associated with user information stored in the account;
identifying, responsive to identifying the user, at least one recommended transaction for the user, the at least one recommended transaction based on historical interactions of the user at a provider location;
identifying at least one provider device at the provider location with functionality capable of assisting with the at least one recommended transaction;
receiving real-time status data associated with the at least one provider device;
determining a real-time status of the at least one provider device based on the real-time status data;
based on the real-time status of the at least one provider device indicating that the at least one provider device is available, selecting the at least one provider device for the at least one recommended transaction;
retrieving and queuing up, responsive to the selection of the at least one provider device, the at least one recommended transaction at the at least one provider device for the user based on identifying the user and determining that the user device is within the designated provider location area; and
prompting at least one of the user device or the vehicle regarding the at least one recommended transaction.

16. The non-transitory computer-readable medium of claim 15,
the operations further comprising:
identifying a network address associated with the vehicle; and
providing the prompt to an input/output device of the vehicle based on the network address, wherein the prompt regarding the at least one recommended transaction includes a request for additional authentication information.

17. The non-transitory computer-readable medium of claim 15, wherein the identifier includes a license plate value, and the operations further comprise:
causing a scan of the vehicle;
obtaining an image of the vehicle based on the scan;
analyzing the image to extract the license plate value; and
matching the license plate value to a stored license plate value regarding the vehicle in the account of the user.

18. The non-transitory computer-readable medium of claim 15, wherein the prompt includes a request for authentication information to the user device, the operations further comprising:
receiving authentication information from the user device; and
comparing the received authentication information to information stored in the account of the user.

19. The non-transitory computer-readable medium of claim 15, the operations further comprising:
monitoring the designated provider location area associated with the provider institution; and
providing a message to a display device of the provider institution indicating a lane to use for the vehicle at the provider institution based on the monitored the designated provider location area.

20. The non-transitory computer-readable medium of claim 15, wherein the prompt includes a credential, the operations further comprising:
receiving the credential from a short range wireless communication from the user device to a device associated with the provider institution; and
verifying the credential based on the credential being received within a predefined amount of time following the prompt.
